(19) United States
(12) Patent Application Publication
(10) Pub. No.: US 2017/0302506 A1
(43) Pub. Date: Oct. 19, 2017

(54) METHODS AND APPARATUS FOR FAULT DETECTION

(71) Applicants: Preetam JINKA, Ashburn, VA (US); Baron SCHWARTZ, Charlottsville, VA (US)

(72) Inventors: Preetam JINKA, Ashburn, VA (US); Baron SCHWARTZ, Charlottsville, VA (US)

(21) Appl. No.: 15/487,771

(22) Filed: Apr. 14, 2017

Related U.S. Application Data
(60) Provisional application No. 62/323,334, filed on Apr. 15, 2016.

(51) Int. Cl. H04L 12/24; H04L 12/26

(52) U.S. Cl. CPC H04L 41/0631; H04L 43/0817; H04L 41/0681; H04L 41/069

(57) ABSTRACT

A system includes a set of detection devices coupled to a host device in a network. Each detection device includes a database configured to store an observation value for a variable, the observation value associated with operation of the host device at a time. Each detection device also includes a processor configured to analyze the observation value based on a criterion to generate an outcome. The criterion is associated with a criterion value, and the criterion value associated with that detection device is different than a criterion value associated with each remaining detection device. The system also includes a group device that includes a processor configured to receive a set of outcomes from the set of detection devices, and to compute an indication of a state of the host device as operating with or without fault based on the set of outcomes.

### CROSS-REFERENCE TO RELATED APPLICATION

This applications claims priority to U.S. Provisional Application No. 62/323,334 titled “METHODS AND APPARATUS FOR FAULT DETECTION”, filed Apr. 15, 2016, the entire disclosure of which is incorporated herein by reference.

### BACKGROUND

Embodiments described herein relate generally to fault detection within a computing system. Some known fault detection systems use predefined, static thresholds to detect abnormal behaviors in a system or process. Such known fault detection systems, however, are typically not applicable to detect anomalies for a dynamic system or process, and are unable to detect unknown types of system or process faults. Some other known fault detection systems use dynamic or adaptive thresholds to detect abnormal behaviors. Such known fault detection systems, however, typically do not distinguish improbable or unusual behavior (i.e., abnormality) from bad behavior (i.e., fault). Moreover, such known fault detection systems typically are computationally expensive, thus infeasible to operate on a large scale and in substantially real-time. Further, employing a single fault detection device or system can provide for limited fault analysis and a critical point of failure.

Accordingly, a need exists for methods and apparatus that 1) can dynamically and automatically detect anomalies, 2) can distinguish faults from abnormal behaviors, 3) are computationally inexpensive and scalable, and 4) can resolve different fault determinations from different entities.

### SUMMARY

In some embodiments, a system includes a set of detection devices configured to be communicably coupled to a host device in a network. Each detection device from the set of detection devices includes a database configured to store an observation value for a variable. The observation value for the variable is associated with operation of the host device at a time. Each detection device from the set of detection devices also includes a processor operatively coupled to the memory and configured to analyze the observation value based on a criterion to generate an outcome. The criterion is associated with a criterion value, the criterion value associated with that detection device being different than a criterion value associated with each remaining detection device from the set of detection devices. The system also includes a group device configured to be communicably coupled to the set of detection devices via the network. The group device includes a processor configured to receive a set of outcomes from the set of detection devices. Each outcome from the set of outcomes includes the outcome being uniquely associated with a detection device from the set of detection devices. The processor of the group device is further configured to compute an indication of a state of the host device as operating with or without fault based on the set of outcomes. The processor of the group device is further configured to transmit, over the network, the indication of the state of the host device.

### BRIEF DESCRIPTION OF THE DRAWINGS

FIG. 1 is a schematic diagram that illustrates a detection device configured to detect anomalies of a system or process, according to an embodiment.

FIG. 2 is a flow chart illustrating a method for fault detection based on a deviation value for a variable, according to an embodiment.

FIG. 3 is a flow chart illustrating a method for fault detection based on an observation value of a first variable, an observation value of a second variable, and a stableness value of the first variable, according to an embodiment.

FIG. 4 is a schematic diagram that illustrates the detection device of FIG. 1 performing a detection process, according to an embodiment.

FIG. 5 is a flow chart illustrating a method for detecting faults, according to an embodiment.

FIG. 6 is a flow chart illustrating a method for computing deviation from normality for a variable, according to an embodiment.

FIG. 7 is a diagram illustrating results of performing a detection method for a system or process, according to an embodiment.

FIG. 8 is a schematic diagram that illustrated a group device and a set of detection devices configured to detect anomalies of a system or process, according to an embodiment.

FIG. 9A illustrates normalcy thresholds with upper and lower limits for an example signal.

FIG. 9B illustrates normalcy thresholds with upper and lower limits for an example signal when using upper and lower EWMAs.

FIGS. 10A-10F are example data sets illustrating fault detection in a first variable (FIGS. 10A, 10C, 10E) and a second variable (FIGS. 10B, 10D, 10F).

FIG. 11 is a schematic diagram that illustrates a group device configured to detect anomalies of a system or process, according to an embodiment.

FIG. 12 is a flow chart illustrating a method for outcome determination using a detection device, according to an embodiment.

### DESCRIPTION

In some embodiments, a method includes receiving, at a detection device in a network, an observation value for a variable. The observation value for the variable is associated with operation of a host device in the network at a time. The method also includes analyzing, at the detection device, the observation value based on a criterion to generate an outcome, the criterion being associated with a criterion value. The criterion value associated with the detection device is different than a criterion value associated with other detection devices in the network. The method also includes sending, to a group device in the network, the outcome such that the group device computes an indication of a state of the host device based on the outcome.

In some embodiments, a device (also sometimes referred to as a “group device”) operably coupled to a network includes a processor configured to receive a set of outcomes from a set of detection devices via the network. Each outcome from the set of outcomes is generated by a different detection device from the set of detection devices. Each outcome from the set of outcomes is based on an observation value that is for a variable and that is associated with operation of a host device in the network at a time. Each outcome from the set of outcomes is further based on a criterion associated with a criterion value that is associated with each detection device from the set of detection devices and that is different than the criterion value associated with each remaining detection device from the set of detection devices. The processor is further configured to compute an indication of a state of the host device as operating with or without fault based on the set of outcomes, and to transmit, over the network, the indication of the state of the host device. The device also includes a database operatively coupled to the processor, the database configured to store at least one of the observation value, the set of outcomes, or the indication of the state of the host device.

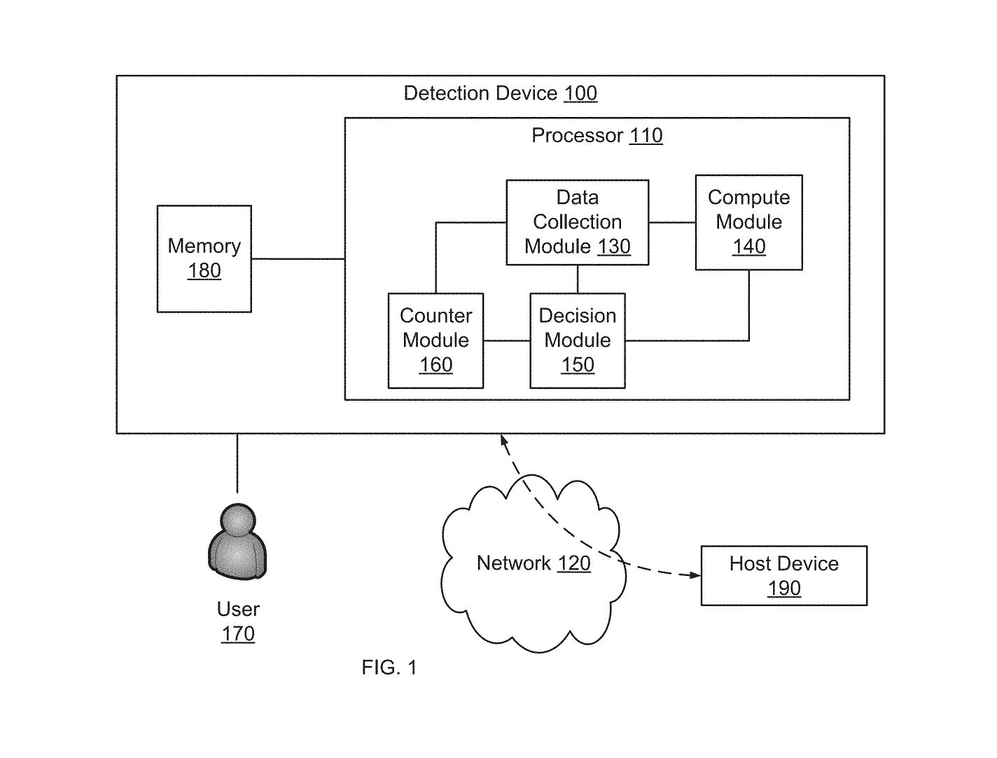

FIG. 1 is a schematic diagram that illustrates a detection device/apparatus 100 configured to observe operation of an operational entity 190 (sometimes referred to as a processing system, and/or as a host device). FIG. 1 illustrates the operational entity 190 as a host device, though it is understood that the host device can be any suitable entity being observed including, but not limited to, another device, apparatus, system, process, a thread executing within a process, and/or the like, including any sub-component (e.g., a sub-system) thereof. The observed operation can be any operational aspect of the operational entity 190, such as throughput, concurrency, consistency, and/or the like.

In some instances, the operation generates, is controlled by, and/or is otherwise associated with one or more observable parameters, variables, and/or the like. In such instances, observing the operation can include measuring, estimating, monitoring, analyzing, and/or receiving a value associated with the variable(s). In some instances, computation can be performed on the received variable value(s) to further analyze the operation.

As an example, in some instances, the detection device 100 can be configured to detect anomalies of a system or process executed at the host device 190. The host device 190 can be any device configured to host a system or execute a process that receives demand and responds to the demand in a manner that generates observable characteristics, such as, for example, throughput. The host device 190 can be, for example, a server, a compute device, a router, a data storage device, and/or the like. The system or process associated with the host device 190 can include, for example, computer software (stored in and/or executed at hardware) such as web application, database application, cache server application, queue server application, application programming interface (API) application, operating system, file system, etc.; computer hardware such as network appliance, storage device (e.g., disk drive, memory module), processing device (e.g., computer central processing unit (CPU)), computer graphic processing unit (GPU)), networking device (e.g., network interface card), etc.; and/or combinations of computer software and hardware (e.g., assembly line, automatic manufacturing process). In some embodiments, although not shown in FIG. 1, the detection device 100 can be operatively coupled to more than one host device or other devices, such that the detection device 100 can substantially simultaneously observe (e.g., to detect anomalies) more than one system and/or process according to embodiments described herein.

The detection device 100 can be any device with certain data processing and computing capabilities such as, for example, a server, a workstation, a compute device, a tablet, a mobile device, and/or the like. As shown in FIG. 1, the detection device 100 includes a memory 180, a processor 110, and/or other component(s) (not shown in FIG. 1). The memory 180 can be, for example, a Random-Access Memory (RAM) (e.g., a dynamic RAM, a static RAM), a flash memory, a removable memory, and/or so forth. In some embodiments, instructions associated with performing the operations described herein (e.g., fault detection) can be stored within the memory 180 and executed at the processor 110. The processor 110 includes a data collection module 130, a compute module 140, a counter module 160, a decision module 150, and/or other module(s) (not shown in FIG. 1). The detection device 100 can be operated and controlled by a user 170 such as, for example, an operator, an administrator, and/or the like.

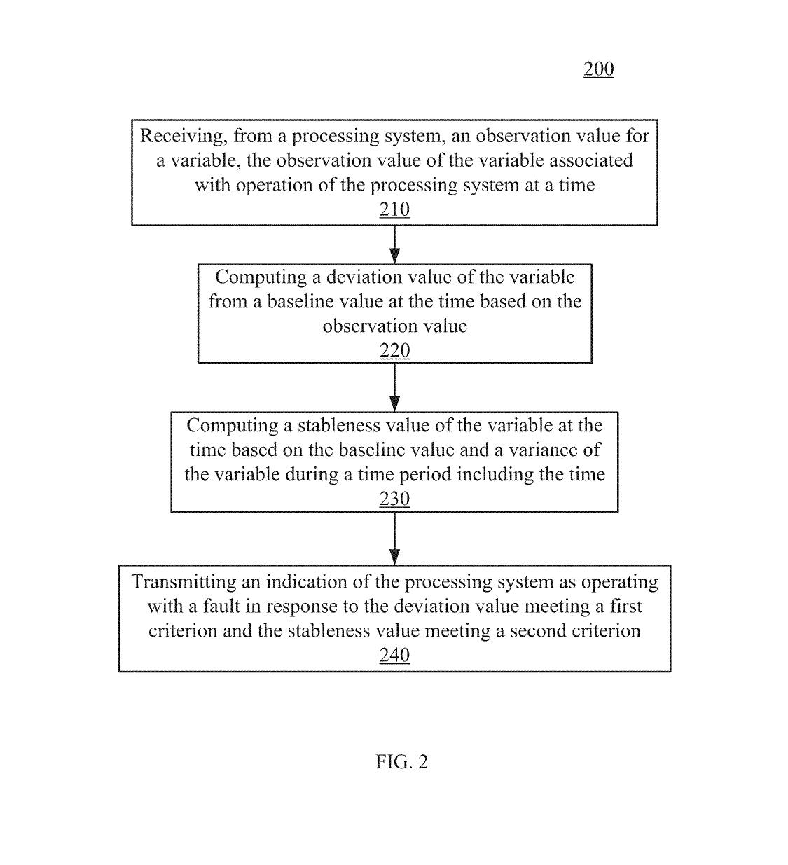

Each module in the processor 110 can be any combination of hardware-based module (e.g., a field-programmable gate array (FPGA), an application specific integrated circuit (ASIC), a digital signal processor (DSP)), software-based module (e.g., a module of computer code stored in the memory 180 and/or executed at the processor 110), and/or a combination of hardware- and software-based modules. Each module in the processor 110 is capable of performing one or more specific functions/operations as described herein (e.g., associated with a detecting operation), as described in further detail with respect to FIGS. 2-6. In some embodiments, the modules included and executed in the processor 110 can be, for example, a process, application, virtual machine, and/or some other hardware or software module (stored in memory and/or executing in hardware). The processor 110 can be any suitable processor configured to run and/or execute those modules.

In other embodiments, the processor 110 can include more or less modules than those shown in FIG. 1. For example, the processor 110 can include more than one compute module to simultaneously perform multiple computing tasks for multiple systems and/or processes. In some embodiments, the detection device 100 can include more components than those shown in FIG. 1. For example, the detection device 100 can include a communication interface (e.g., a data port, a wireless transceiver and an antenna) to enable data transmission between the detection device 100 and the host device 190. In some embodiments, the detection device 100 can include or be coupled to a display device (e.g., a printer, a monitor, a speaker, etc.), such that an output of the detection device (e.g., a detection result) can be presented to the user 170 via the display device.

As used herein, a module can be, for example, any assembly and/or set of operatively-coupled electrical components associated with performing a specific function, and can include, for example, a memory, a processor, electrical traces, optical connectors, hardware executing software and/or the like. As used herein, the singular forms “a,” “an” and “the” include plural referents unless the context clearly dictates otherwise. Thus, for example, the term “a compute module” is intended to mean a single module or a combination of modules configured to execute computing tasks associated with detecting anomalies of a system or process.

As shown in FIG. 1, the detection device 100 can be operatively coupled to the host device 190 via, for example, a network 120. The network 120 can be any type of network that can operatively connect and enable data transmission between the detection device 100 and the host device 190. The network 120 can be, for example, a wired network (an Ethernet, local area network (LAN), etc.), a wireless network (e.g., a wireless local area network (WLAN), a Wi-Fi network, etc.), or a combination of wired and wireless networks (e.g., the Internet, etc.). For example, the detection device 100 can be a server placed at a centralized location in a data center and connected, via a LAN, to multiple host devices (similar or identical to the host device 190) that are distributed within the data center. Each host device can host and maintain a system (e.g., a file system), and/or execute a process (e.g., a web service). In such a deployment, the detection device 100 can monitor the operation of the multiple host devices, such as for detecting anomalies in the systems and processes hosted or executed at those host devices. In some other embodiments, the detection device 100 can be physically connected to the host device 190. In yet other embodiments, the detecting functionalities of the detection device 100 can be implemented within the host device 190. For example, an example detection process (e.g., a detection process 200 shown and described with respect to Example 1 and FIG. 2) can be executed (stored in a memory and executed at hardware) within the host device 190, such that a detection result associated with the system or process of the host device 190 can be generated at the host device 190 and reported to a user.

The operation of the various modules is explained herein with reference to a single variable of a single operation on the host device 190 for simplicity, though it is understood that unless explicitly stated otherwise, aspects of the modules described herein are extendible to multiple variables, to multiple operations, and/or to multiple devices.

In some instances, the data collection module 130 can be configured to receive, from the host device 190, an observation value for a variable. In some instances, the observation value of the variable is associated with operation of the host device 190 at a time. In some instances, the time can be anytime in the past, such that the observation value of the variable is associated with operation of the host device 190 at a past time. In some instances, the observation value is received substantially in real time, such that the observation value of the variable is associated with current operation of the host device 190.

While not shown in FIG. 1, in some embodiments an agent associated with the detection device 100 can be installed and/or execute on the host device 190. The agent can monitor operational status of the host device 190 and/or provide updates on the operational status of the host device 190 to the data collection module 130.

In some instances, the compute module 140 is operatively coupled to the data collection module 130, and can be configured to compute a deviation value of the variable from a baseline value based on the observation value. In some instances, the baseline value is an average value of the variable over any suitable time period, or time window. In some instances, the baseline value is an exponentially weighted moving average (EWMA) of the variable. In some instances, the compute module 140 can be configured to set the deviation value of the variable to zero if the standard deviation of the variable is less than or equal to a threshold for the standard deviation. In some instances, the threshold for the standard deviation is zero.

In some instances, the deviation value is inversely correlated with a standard deviation of the variable at the time. Similarly stated, in such instances, the deviation value decreases as the standard deviation of the variable at the time increases. In some instances, the compute module 140 is configured to compute the deviation value by 1) subtracting the baseline value from the observation value, and 2) dividing the result by the standard deviation of the variable at the time.

In some embodiments, the counter module 160 is operatively coupled to the compute module 140, and is configured to determine that a predetermined number of observations for the variable has been received prior to the time. In such embodiments, the compute module can be configured to compute the deviation value of the variable based on the predetermined number of observations being received. In some instances, the predetermined number of observations is zero. In this manner, the predetermined number of observations can be tuned to affect how rapidly after initiating monitoring of the variable the detection device 100 begins evaluating deviation of the variable.

In some embodiments, the decision module 150 is operatively coupled to the compute module 140, and can be configured to determine if the observation value meets a criterion (sometimes referred to as a first criterion, or as a second criterion) for the observation value. In some instances, the compute module 140 updates a previously calculated baseline value to account for the observation value. For example, in some instances, the baseline value is based on an exponential smoothing operation performed on the variable, such as, for example, an exponentially weighted moving average (EWMA) of the variable, and the updated baseline value is a EWMA for the variable that reflects the most recent observation (i.e., the observation value). In such instances, the criterion for the observation value can be based on the previously calculated baseline value of the variable, or on the updated baseline value of the variable. For example, the baseline value can be an EWMA computed by the compute module 140 that includes the observation value. In some embodiments, the baseline value is based on an EWMA of the difference between consecutive variable measurements/values. For example, considering that an EWMA can be qualitatively described as an indication of the trending value for the variable, then an EWMA (of the difference between consecutive variable measurements/value) of 1.5 indicates that each variable measurement/value will generally tend to be about 1.5 times larger than the previous variable measurement/value.

In some instances, the baseline value is based on a double exponential smoothing operation performed on the variable, such as, for example, a double exponentially weighted moving average of the variable (double EWMA), and the updated baseline value is a double EWMA for the variable that reflects the most recent observation. In some instances, the baseline value is based on a double EWMA of the difference between consecutive variable measurements/values.

In some instances, the baseline value is based on a weighted histogram of the variable, such as, for example, an exponential weighted histogram that includes a probability distribution of the variable. In this manner, the decision module 150 can be configured to determine how much an observed variable value differs and/or deviates from earlier variable values by observing the histogram.

In some instances (also referred to herein as a “bootstrapping approach”), the baseline value is one of a set of baseline values being estimated and/or otherwise inferred based on a smaller set of previously observed values for the variable. For example, in some embodiments, sampling of a distribution of the previously observed values can be used for identifying the set of baseline values.

In some instances, the decision module 150 is configured to identify one or more approaches to calculate, update, and/or otherwise determine the baseline value from the variable. The one or more approaches can include any suitable operation such as, but not limited to, EWMA, double EWMA, EWMA of the difference between consecutive variable measurements/values, double EWMA of the difference between consecutive variable measurements/values, a weighted histogram, an exponential weighted histogram, and/or a bootstrapping approach. In some instances, the decision module 150 is configured to switch between approaches to calculate, update, and/or otherwise determine the baseline value from the variable. In some embodiments, the switching is based on a deterministic or probabilistic scoring approach, such as, for example, a self-scoring approach, as described herein. In some instances, the decision module 150 identifies one or more approaches based on the variable being observed. For example, in some instances, the variable being observed is associated with database operation, and the decision module 150 is configured to employ EWMA. As another example, the variable being observed is associated with a disk drive operation, and the decision module 150 is configured to employ double EWMA.

In some instances, the criterion for the observation value is a threshold, and the observation value meets the criterion for the observation value when the observation value is greater than the threshold for the observation value. In other instances, the observation value meets the criterion for the observation value when the observation value is less than or equal to the threshold for the observation value. In yet other instances, the observation value meets the criterion for the observation value when, compared with a last received observation value, the observation value crosses the threshold for the observation value. In yet other instances, the observation value meets the criterion when the observation value is greater than the threshold for the observation value for a predetermined period of time.

In some instances, the decision module 150 can be configured to determine if the deviation value meets a criterion (sometimes referred to as a first criterion, a second criterion, a third criterion, a fourth criterion, or a fifth criterion) for the deviation value. In some instances, the criterion for the deviation value is a threshold (sometimes referred to as a normalcy threshold) for the deviation value, and the deviation value meets the criterion for the deviation value when the deviation value is greater than the threshold for the deviation value. In other instances, the deviation value meets the criterion for the deviation value when the deviation value is less than or equal to the threshold for the deviation value. In yet other instances, the deviation value meets the criterion for the deviation value when, when compared with a last calculated deviation value, the deviation value crosses the threshold for the deviation value. In yet other instances, the deviation value meets the criterion when the deviation value is greater than the threshold for the deviation value for a predetermined period of time.

In some instances, the decision module 150 can be configured to send an indication, to a user device, that the host device 190 is operating with a fault at the time in response to the observation value meeting the criterion for the observation value. In some embodiments, the decision module 150 can be configured to send an indication, to the user device, that the host device 190 is operating with a fault at the time in response to the deviation value meeting a criterion for the deviation value. In some instances, the decision module 150 can be configured to send an indication, to a user device, that the host device 190 is operating with a fault at the time in response to the observation value meeting the criterion for the observation value and the deviation value meeting the criterion for the deviation value.

In some instances, the compute module 140 can be further configured to compute a stableness value of the variable at the time based on the baseline value and a variance of the variable during a time period that includes the time. The time period can be any suitable measurement window for the variable. In such instances, the decision module 150 can be further configured to send an indication that the host device 190 is operating with a fault in response to the observation value meeting the criterion for the observation value, the deviation value meeting the criterion for the deviation value, and the stableness value meeting a criterion for the stableness value. In some instances, the criterion for the stableness value is a threshold (sometimes referred to as a stability threshold) for the stableness value, and the stableness value meets the criterion for the stableness value when the stableness value is greater than the threshold for the stableness value. In other instances, the stableness value meets the criterion for the stableness value when the stableness value is less than or equal to the threshold for the stableness value. In yet other instances, the stableness value meets the criterion for the stableness value when, compared with a last calculated stableness value, the stableness value crosses the threshold for the stableness value. In yet other instances, the stableness value meets the criterion when the stableness value is greater than the threshold for the stableness value for a predetermined period of time.

In some instances, the variance of the variable is an exponentially weighted moving variance (EWMV) of the variable. In some instances, the stableness value is directly correlated with the variance of the variable. Similarly stated, in such instances, the stableness value increases as the variance of the variable increases. In some instances, the compute module 140 can be further configured to compute the stableness value by dividing the variance of the variable by the baseline value of the variable.

In some instances, the variable is a first variable and the time is a first time within the time period. The data collection module 130 can be further configured to receive an observation value for a second variable associated with operation of the host device 190 at a second time within the time period. In some instances, the compute module 140 can be further configured to compute a deviation value of the second variable from a baseline value of the second variable based on the observation value for the second variable. In some instances, the decision module 150 can be further configured to send an indication that the host device is operating with a fault at the second time in response to the deviation value of the first variable meeting the first criterion, the deviation value of the second variable meeting a second criterion, and a stableness value of the first variable meeting a third criterion. In some instances, the decision module 150 can be further configured to send an indication that the host device is operating with a fault at the second time in response to the ratio of the baseline value of the first variable to the baseline value of the second variable meeting a criterion, e.g., being below a predetermined threshold.

FIG. 2 illustrates a method 200, according to an embodiment. In some instances, the method 200 can be performed by the processing device 100 of FIG. 1. The method 200 includes, at 210, receiving, at a data collection module implemented in at least one of a memory or a processing device (e.g., the data collection module 130), from a processing system (e.g., the host device 190), an observation value of a variable. The observation value of the variable is associated with operation of the processing system at a time. At 220, a deviation value of the variable is computed from a baseline value at the time based on the observation value. At 230, a stableness value of the variable is computed at the time based on the baseline value and a variance of the variable during a time period including the time. At 240, an indication that the processing system is operating with a fault is transmitted in response to the deviation value meeting a first criterion and the stableness value meeting a second criterion.

In some instances, the deviation value can be inversely correlated with a standard deviation of the variable at the time. Similarly stated, in such embodiments, the deviation value decreases as the standard deviation of the variable at the time increases. In some instances, computing the deviation value of the variable can include setting the deviation value of the variable to zero if the standard deviation of the variable is less than a threshold. In some instances, the deviation value of the variable meets the first criterion if the deviation value of the variable is greater than or equal to a normalcy threshold for the variable.

In some instances, transmitting the indication of the processing system as operating with a fault is further in response to the observation meeting a third criterion defined based on the baseline value. In some instances, the baseline value is an exponentially weighted moving average (EWMA) of the variable.

In some instances, the stableness value is directly correlated with the variance of the variable. Similarly stated, in such instances, the stableness value increases as the variance of the variable increases. In some instances, the variance of the variable is an exponentially weighted moving variance (EWMV) of the variable. In some instances, the stableness value of the variable meets the second criterion if the stableness value is less than a stability threshold.

In some instances, the variable is a first variable, and the method 200 can further include receiving, at the data collection module, from the processing system, an observation value for a second variable associated with operation of the processing system. In some instances, the method 200 can further include computing a deviation value of the second variable from a baseline value of the second variable at the time based on the observation value for the second variable. In some instances, the method 200 can further include transmitting an indication of the processing system as operating with a fault in response to the deviation value of the first variable meeting the first criterion, the stableness value meeting the second criterion, and the deviation value of the second variable meeting a third criterion.

In some instances, the variable is a first variable, and the method 200 can further include receiving, at the data collection module, from the processing system, an observation value for a second variable associated with operation of the processing system. In some instances, one of the first variable or the second variable is associated with throughput of the processing system, and the other of the first variable and the second variable is associated with concurrency of the processing system. In some instances, the method 200 can further include computing a deviation value of the second variable from a baseline value of the second variable at the time based on the observation value for the second variable. In some instances, the method 200 can further include transmitting an indication of the processing system as operating with a fault in response to the deviation value of the first variable meeting the first criterion, the stableness value meeting the second criterion, and the deviation value of the second variable meeting a third criterion.

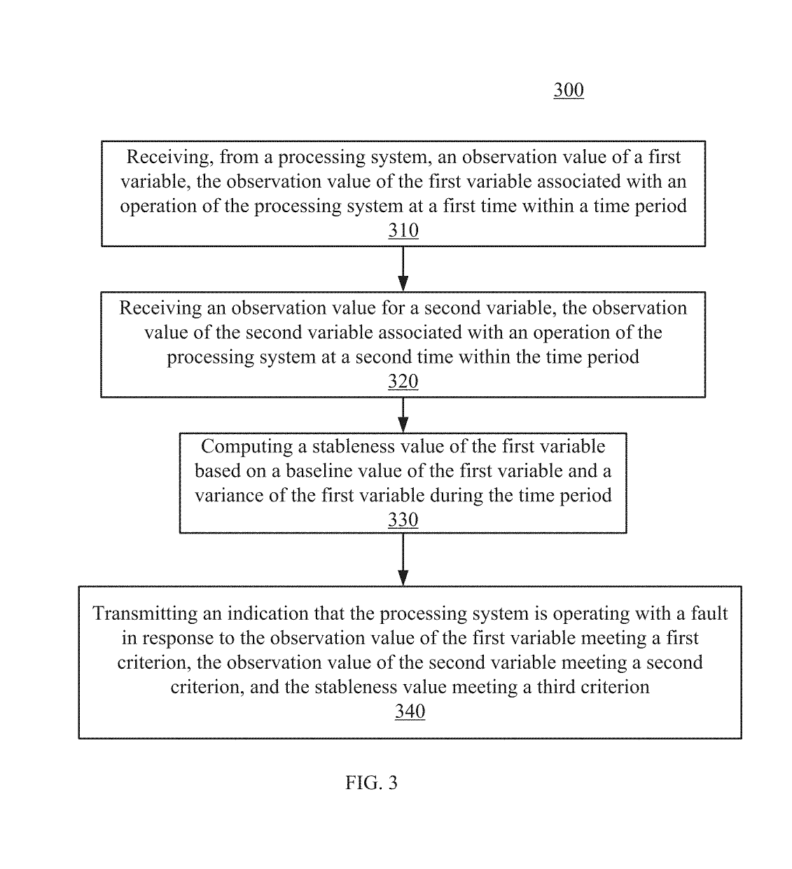

FIG. 3 illustrates a method 300, according to an embodiment. In some instances, the method 300 can be performed by the processing device 100 of FIG. 1. At 310, an observation value of a first variable is received at a data collection module (e.g., the data collection module 130) implemented in at least one of a memory or a processing device (e.g., the processing device 100), from a processing system (e.g., the host device 190). The observation value of the first variable is associated with an operation of the processing system at a first time within a time period. At 320, an observation value for a second variable is received at the data collection module. The observation value of the second variable is associated with an operation of the processing system at a second time within the time period. At 330, a stableness value of the first variable is computed based on a baseline value of the first variable and a variance of the first variable during the time period. At 340, an indication that the processing system is operating with a fault is transmitted in response to the observation value of the first variable meeting a first criterion, the observation value of the second variable meeting a second criterion, and the stableness value meeting a third criterion. In some instances, one of the first variable or the second variable is associated with throughput of the processing system, and the other of the first variable and the second variable is associated with concurrency of the processing system.

In some instances, the method 300 further includes computing a deviation value of the first variable from the baseline value of the first variable at the first time based on the observation value for the first variable. In some instances, the method 300 further includes, computing a deviation value of the second variable from a baseline value of the second variable at the second time based on the observation value for the second variable. In some instances, transmitting the indication is further in response to the deviation value of the first variable meeting a fourth criterion and the deviation value of the second variable meeting a fifth criterion.

In some instances, the method 300 further includes computing the stableness value after receiving a predetermined number of observation values of the first variable and after receiving a predetermined number of observation values of the second variable. In some instances, the stableness value is directly correlated with the variance of the first variable, and the stableness value meets the third criterion if the stableness value is less than a stability threshold. In some instances, any of the first criterion, second criterion, third criterion, fourth criterion, fifth criterion disclosed herein can be programmable.

Embodiments disclosed herein can be beneficial for distinguishing between anomalous/abnormally behaving systems, and faulty systems. As an example, in some instances, a system would be deemed as not faulty if any of the following scenarios occur, upon receiving an observation value of throughput of the system:
the throughput is greater than the mean of the throughput—the system can be deemed to be performed normally since it is completing the work requested of it; or
the deviation of the throughput, updated to reflect the observation value, is greater than a normalcy threshold. The deviation of throughput, in turn, is inversely correlated to the standard deviation of the throughput. If the system has perpetually highly variable behavior, the standard deviation is high, the resulting deviation is low, and the deviation is less likely to exceed the normalcy threshold; or
the ratio of variance of throughput to the mean of the throughput is greater than a stability threshold. If the throughput of the system varies greatly (e.g., has a high variance relative to the mean), the baseline (e.g., mean) of the throughput is less likely to be significant. Similarly, if the throughput of the system is substantially constant (e.g., has a low variance relative to the mean), the baseline (e.g., mean) of the throughput is more likely to be significant. For example, a high value of variance or a low value of the mean of throughput will result in a higher value of the ratio, so the ratio is more likely to exceed the stability threshold.

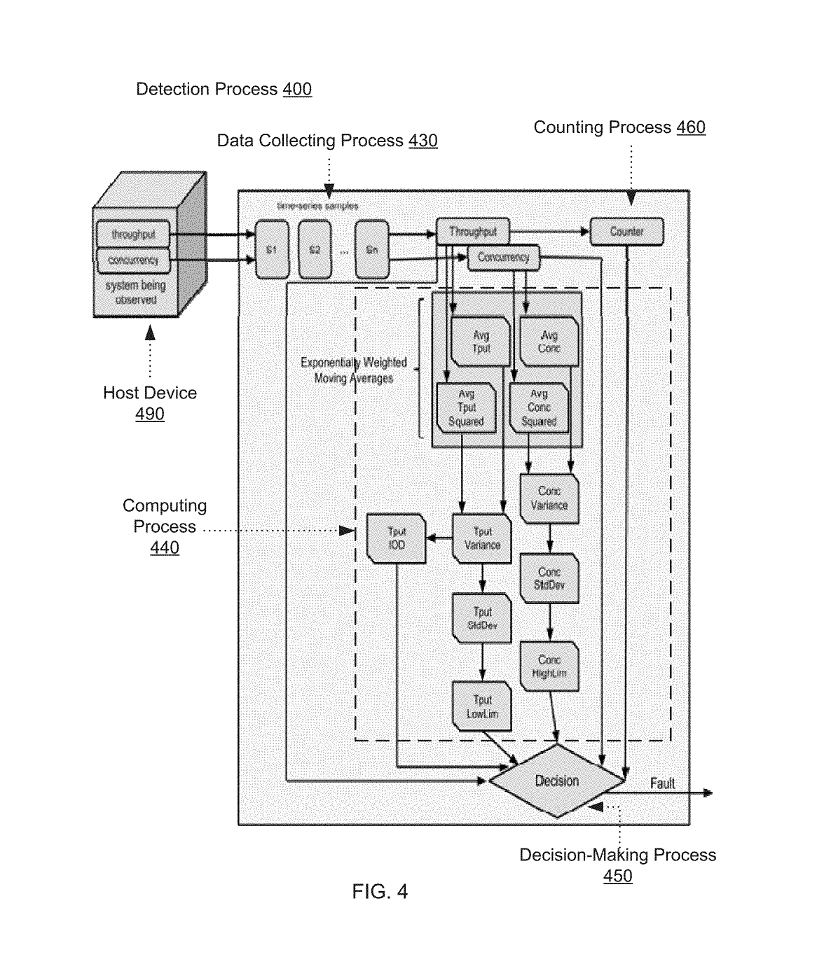

FIG. 4 is a schematic diagram that illustrates the detection device 100 of FIG. 1 performing a detection process 400, according to an embodiment. Each module in the processor 110 (shown in FIG. 1) can be configured to perform a portion of the detection process 400, as described in detail below.

The data collection module 130 (shown in FIG. 1) can be configured to perform a data collecting process 430 (shown in FIG. 4). Specifically, the data collection module 130 can receive, from the host device 190 (which can be structurally and/or functionally similar to the host device 490 illustrated in FIG. 4), observation data (e.g., “S1”, “S2”, “Sn” shown in FIG. 4) associated with the system or process being monitored. In some instances, the data collection module 130 can collect the observation data by, for example, periodically (e.g., once per second) sending data queries to the host device 190. In response to the data queries, the host device 190 can send requested observation data to the detection device 100. In some other instances, the host device 190 can be configured to provide the observation data in a certain manner (e.g., periodically, when a change in the data pattern is detected), and the detection device 100 can passively receive the observation data. For example, a server software executed at the host device 190 and associated with a system being monitored can periodically provide observation data to the detection device. In such instances, the detection device 100 can gather the observation data from the host device 190 without intruding upon the system or process being monitored.

In some instances, the observation data received from the host device 190 can include observation data on two variables associated with the system or process being monitored: throughput and concurrency. The throughput variable can be defined as the number of units of work completed per unit of time within the system or process. For example, for a database server, a throughput variable can be measured (e.g., by an agent at the database server) as queries that are handled by the database server per second. For another example, for a web server, a throughput variable can be measured (e.g., by an agent at the web server) as requests that are served by the web server per second. The concurrency variable can be defined as the number of units of work executing substantially simultaneously or substantially concurrently within the system or process at a given time. For example, for a database server, a concurrency variable can be measured (e.g., by an agent at the database server) as the number of client queries executing within the system or process at a given time. Typically, the values of the throughput variable and the concurrency variable change with time. Thus, measurements of the values of the two variables can be collected at different times and provided to the detection device 100 as series of observation data for detecting anomalies. Accordingly, as used herein, a variable can include and/or be associated with multiple observation values (e.g., an array or list of observation values). Each observation value of a variable can be associated with a measurement or observation of the variable (e.g., throughput, concurrency, etc.) at a given time. As described below, calculations on a variable can include calculations on the observation values associated with that variable. Thus, for example, a “mean of a variable” is the mean of the observation values of that variable.

The counter module 160 (shown in FIG. 1) can be configured to perform a counting process 460 (shown in FIG. 4). Specifically, the counter module 160 can maintain and operate one or more counters to record the number of observation data (e.g., the throughput variable and/or the concurrency variable) received in the data collecting process 430. Such a count result can be used in a decision-making process 450 as shown in FIG. 4 and described below. In some instances, the counter module 160 can maintain a counter for each variable being monitored (e.g., a first counter for the throughput variable, a second counter for the concurrency variable). In some instances, a counter maintained at the counter module 160 can be reset or modified based on, for example, a control instruction or a predefined circumstance. For example, the counter for the throughput variable can be reset to zero after a fault is detected based on the observation data of the throughput variable. For another example, the counter for the concurrency variable can be modified (e.g., decreased by one) in response to receiving an instruction indicating an outlier observation on the concurrency variable.

The compute module 140 (shown in FIG. 1) can be configured to perform a computing process 440 (shown in FIG. 4). Specifically, the compute module 140 can calculate, based on the observation data (e.g., of the throughput variable and/or of the concurrency variable) received from the host device 190, intermediate results that can be used in the final decision-making process 450. In some instances, the intermediate results include a metric representing deviation from normality for the observation data of the throughput variable (referred as “deviation of throughput” herein) and a metric representing deviation from normality for the observation data of the concurrency variable (referred as “deviation of concurrency” herein). As described in further detail herein, FIG. 4 depicts a method for computing a deviation from normality for a variable.

The decision module 150 (shown in FIG. 1) can be configured to perform the decision-making process 450 (shown in FIG. 4). Specifically, the decision module 150 can make a detection decision based on the intermediate results calculated from the computing process 440, the observation data received in the data collecting process 430, and/or the counter values provided from the counting process 460. In some embodiments, a detection decision can include, for example, a determination on whether a fault occurs in the system or process being monitored (e.g., at the host device 190 of FIG. 1). Finally, the detection device 100 can present the detection decision to, for example, a user (e.g., the user 170 in FIG. 1) such that the user can further examine the system or process.

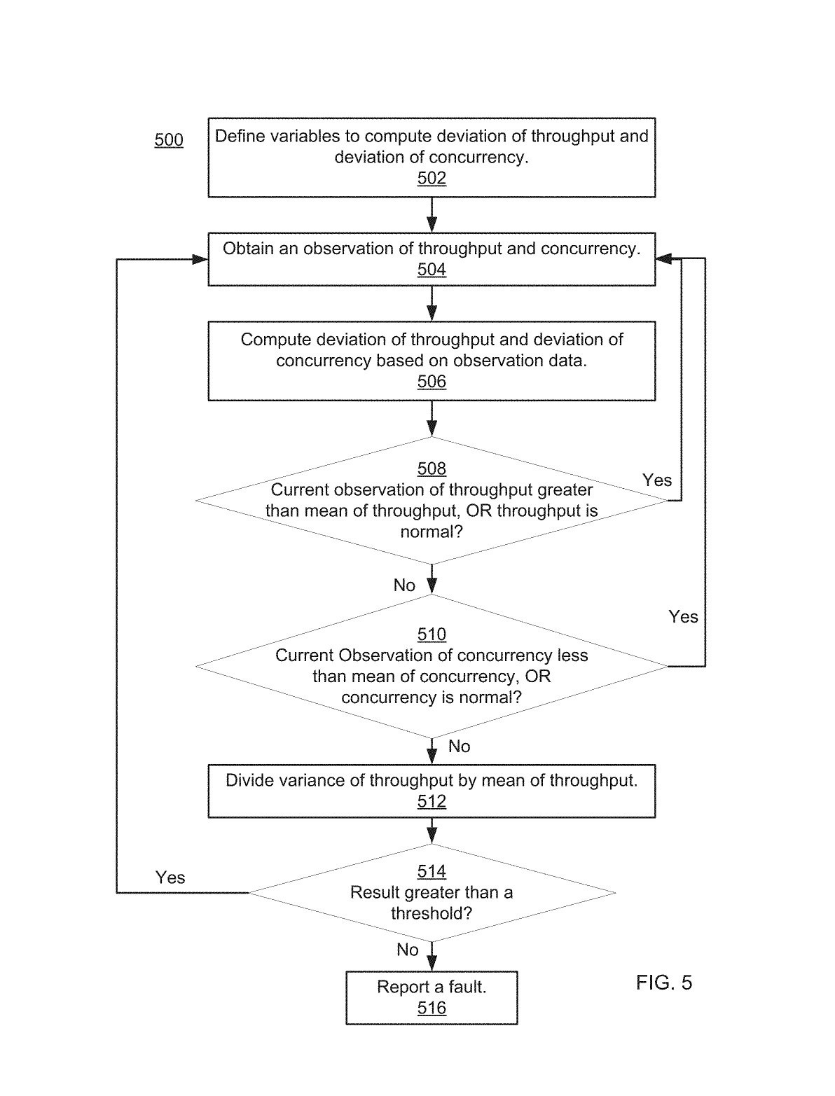

FIG. 5 is a flow chart illustrating a method 500 for detecting faults, according to an embodiment. The code representing instructions to perform the method 500 can be stored in, for example, a non-transitory processor-readable medium (e.g., the memory 180 in FIG. 1) in a detection device that is similar to the detection device 100 shown and described with respect to FIG. 1. Particularly, the detection device can be operatively coupled to a host device (similar to the host device 190 in FIG. 1) that executes a system or process being monitored. The code stored in the non-transitory processor-readable medium (e.g., the memory 180 in FIG. 1) of the detection device can be executed by a processor of that detection device similar to the processor 110 in FIG. 1. Specifically, each portion of the code can be executed by a module of the processor that is similar to the module 130, 140, 150, or 160 shown and described with respect to FIGS. 1 and 4. As such, the method 500 can be similar to the detection process 400 shown and described with respect to FIG. 4. The code includes code to be executed by the processor to cause the detection device to perform the operations illustrated in FIG. 5 and described as follows.

At 502, a compute module (e.g., the compute module 140 in FIG. 1) of the detection device can define variables to compute deviation of throughput and deviation of concurrency. To calculate deviation of an observed variable (e.g., the throughput variable, the concurrency variable), the compute module can define 1) a parameter to store a current value of the observed variable (e.g., value of the most recently received observation of the variable), 2) a mean of the observation data of the observed variable (e.g., the “Avg Tput” and “Avg Conc” in FIG. 4), and 3) a mean of square of the observation date of the variable (e.g., the “Avg Tput Squared” and “Avg Conc Squared” in FIG. 4). Additionally, a counter module (e.g., the counter module 160 in FIG. 1) of the detection device can maintain a counter for each observed variable, and update the counter with each received observation of the variable.

In some instances, the mean of a variable can be defined as the exponentially weighted moving average (EWMA) of the observation data of the variable with an average observation age of a predefined number of samples. The predefined number can be, for example, 20, 30, 40 or another predefined number. In some embodiments, such an average observation age can be calibrated to reflect different degrees of emphasis placed on the recent behavior of the variable. Specifically, a shorter average observation age places less weight on the recent behavior of the variable and more weight on the current observation value of the variable (e.g., value of the most recently received observation of the variable). Similarly, the mean of the square of a variable can be defined as the EWMA of the square of the observation data of the variable with a pre-defined average observation age of a predefined number of samples. In other instances, a mean of a variable (or a mean of the square of a variable) can be defined in any other suitable method such as, arithmetic mean, geometric mean, harmonic mean, etc.

For example, in FIG. 4, “Throughput” represents the current value of the throughput variable (i.e., the most recently received observed throughput value); “Concurrency” represents the current value of the concurrency variable (i.e., the most recently received observed concurrency value); “Avg Tput” represents the mean (e.g., EWMA) of the throughput variable (i.e., the mean of the observation data of the throughput variable for a predefined number of samples); “Avg Conc” represents the mean (e.g., EWMA) of the concurrency variable (i.e., the mean of the observation data of the concurrency variable for a predefined number of samples); “Avg Tput Squared” represents the mean (e.g., EWMA) of the square of the throughput variable (i.e., the mean of the square of the observation data of the throughput variable for a predefined number of samples); and “Avg Conc Squared” represents the mean (e.g., EWMA) of the square of the concurrency variable (i.e., the mean of the observation data of the concurrency variable for a predefined number of samples).

At 504, a data collecting module (e.g., the data collecting module 130 in FIG. 1) of the detection device can obtain an observation (e.g., “S1”, “S2,” “Sn” in FIG. 4) of the throughput variable and an observation of the concurrency variable. This step is similar to the data collecting process 430 shown and described with respect to FIG. 4.

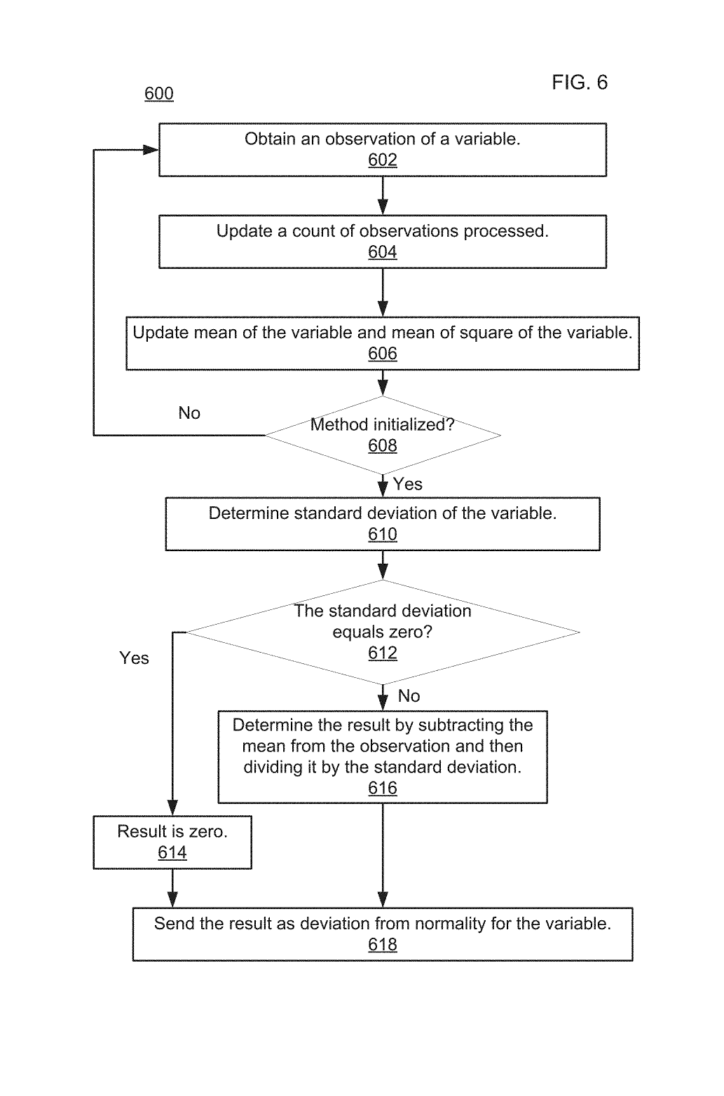

At 506, the compute module of the detection device can compute deviation of throughput and deviation of concurrency. FIG. 6 is a flow chart illustrating a method 600 for computing deviation from normality for a variable (e.g., the throughput variable, the concurrency variable), according to an embodiment. Similar to the method 500, the code representing instructions to perform the method 600 can be stored in a non-transitory processor-readable medium (e.g., the memory 180 in FIG. 1), and executed by a processor (e.g., the processor 110 in FIG. 1), of a detection device (e.g., the detection device 100 in FIG. 1). The method 600 can be similar to the computing process 440 shown and described with respect to FIG. 4. Particularly, the method 600 can be used to detect anomaly or abnormality in the variable (i.e., in a value of the variable). Such an anomaly detection method can be applied to the throughput variable, the concurrency variable, or any other arbitrary variable that is observable from the system or process being monitored. The code includes code to be executed by the processor to cause the detection device to perform the operations illustrated in FIG. 6 and described as follows.

At 602, a data collection module (e.g., the data collection module 130 in FIG. 1) of the detection device can obtain an observation of the variable. At 604, a counter module (e.g., the counter module 160 in FIG. 1) of the detection device can update a counter for observations of the variable. For example, in some instances, the counter can be increased by one each time a new observation of the variable is received.

At 606, a compute module (e.g., the compute module 140 in FIG. 1) of the detection device can update a mean of the variable and a mean of square of the variable. As described above with respect to step 502 of the method 500, the mean of a variable can be defined as, for example, the EWMA of the observation data of a variable with a pre-defined average observation age (e.g., 30 samples). Additionally, the compute module can set the value of the most recently received observation to the current value of the observed variable.

At 608, the compute module can determine whether the method 600 is initialized or not. In some embodiments, the compute module determines whether a certain number (as a predefined threshold, e.g., 10, 15) of observations of the variable have been collected and processed. Specifically, the compute module can check the counter for the number of received observations of the variable, and compare the number of the received observations of the variable (stored in the counter) with the predefined threshold. If the number of the received observations of the variable is less than the predefined threshold, the compute module can determine that an insufficient number of observations of the variable have been collected and processed. Thus, the method 600 is not initialized, and the method 600 returns to step 602 to obtain another observation of the variable (as shown in FIG. 6). As a result, the steps 602-608 are iterated repeatedly until a sufficient number of observations of the variable have been collected and processed. If the number of the received observations of the variable is greater than or equal to the predefined threshold, the compute module can determine that a sufficient number of observations of the variable have been collected and processed. Thus, the method 600 is initialized, and can proceed to next step 610. In some embodiments, the threshold for determining the initialization can be calibrated (e.g., by a user of the detection device) to change the number of samples used for the initialization. Specifically, a lower threshold indicates a fewer number of samples for the initialization, thus resulting in a quicker detection process.

At 610, the compute module can determine the standard deviation of the variable based on the collected observations of the variable. In some instances, for example, the standard deviation of a variable can be defined as the square root of the exponentially weighted moving variance (EWMV) of the variable (i.e., the EWMV of the observation data for that variable). A EWMV of a variable can be defined as the difference between the mean (e.g., EWMA) of the variable (i.e., the mean of the observation data for that variable) and the mean (e.g., EWMA) of the square of the variable (i.e., the mean of the square of the observation data of that variable). In other instances, the standard deviation of a variable can be computed using any other suitable method. For example, in FIG. 6, “Tput Variance” represents the variance (e.g., EWMV) of the throughput variable; “Conc Variance” represents the variance (e.g., EWMV) of the concurrency variable; “Tput StdDev” represents the standard deviation of the throughput variable; and “Conc StdDev” represents the standard deviation of the concurrency variable.

At 612, the compute module can determine whether the calculated standard deviation of the variable equals zero. If the calculated standard deviation of the variable equals zero, at 614, a result, as the deviation from normality for the variable, is determined to be zero. Otherwise, if the calculated standard deviation of the variable does not equal zero, at 616, the compute module can calculate the result by subtracting the mean (e.g., EWMA) of the variable from the current value of the variable (i.e., the value of the most recently received observation of the variable), and dividing the result of the subtraction by the calculated standard deviation of the variable (a non-zero value in this scenario). In the second scenario, the result can be a real number ranging from negative infinity to positive infinity except zero.

At 618, the compute module can send the result to, for example, a decision module (e.g., the decision module 150 in FIG. 1) of the detection device for further processing. Such a result (e.g., a real number ranging from negative infinity to positive infinity including zero) can indicate the most recently received observation's deviation from the variable's recent historical behavior of a normalized magnitude. The deviation from normality for the variable (e.g., the deviation of throughput or the deviation of concurrency as defined above) can be used for many purposes including detecting anomaly and/or fault associated with the system or process being monitored. In some instances, although not shown and described herein, the deviation from normality for a variable and/or other variables and methods described herein can be used to, for example, produce a health indicator for a system or process, which can be tracked to detect changes in the system or process; determine correlations between anomalies in variables; trigger data collection at the instant of a fault to support later diagnosis; generate a “fault signature” that can be used to suggest root cause of observed faults based on the root cause of other faults with similar signatures; suggest relevant data and variables that may be fruitful to investigate; and so on.

Returning to FIG. 5, at 506, the deviation of throughput and the deviation of concurrency can be calculated at the compute module using, for example, the method 600 described above. At 508, the compute module can determine whether the current value of the throughput variable (i.e., the value of the most recently received observation of the throughput variable) is greater than the mean (e.g., EWMA) of the throughput variable, and/or whether the performance of the throughput variable is abnormal, as described in further detail herein. If the compute module determines that the current value of the throughput variable (e.g., “Throughput” in FIG. 4) is greater than the mean of the throughput variable (e.g., “Avg Tput” in FIG. 4), the compute module can interpret such a result as an indication that the system or process being monitored is not producing abnormally low throughput. Thus, no anomaly is detected with respect to the throughput variable. Alternatively, if the compute module determines that the performance of the throughput variable is not abnormal (as defined below), the compute module can interpret the result as an indication that no anomaly is detected with respect to the throughput variable. Thus, the method 500 returns to step 504 to collect and process next observation of the throughput variable.

In some embodiments, an abnormal performance for a variable (e.g., the throughput variable, the concurrency variable) can be defined as the deviation from normality for that variable (e.g., the deviation of throughput, the deviation of concurrency) having an absolute value greater than or equal to a predefined threshold (e.g., 2, 3, 4, etc.). In some instances, such a predefined threshold on the absolute value of the deviation from normality for a variable can be calibrated (e.g., by a user of the detection device) to reflect different standards for abnormality and/or adjust sensitivity of the method 300 with respect to different variables. Specifically, a lower threshold for a variable indicates a lower standard of abnormality (easier to satisfy) for the variable, and higher sensitivity (easier to detect abnormality) of the method 500 with respect to the variable.

If the compute module determines that the current value of the throughput variable is less than or equal to the mean of the throughput variable, and the performance of the throughput variable is abnormal (i.e., the absolute value of the deviation of throughput is greater than or equal to the predefined threshold), the compute module can interpret the result as an indication that the system or process being monitored is producing abnormally low throughput. For example, in FIG. 4, “Tput LowLim” represents a variable (e.g., a binary variable, a flag) that indicates whether the throughput is abnormally low. Then the compute module can proceed to step 510 to determine whether the system or process is experiencing abnormally high concurrency.

At 510, similar to step 508, the compute module can determine whether the current value of the concurrency variable (i.e., the value of the most recently received observation of the concurrency variable) is less than the mean (e.g., EWMA) of the concurrency variable, and/or whether the performance of the concurrency variable is abnormal (using the method to determine an abnormal performance of a variable, as described above). If the compute module determines that the current value of the concurrency variable (e.g., “Concurrency” in FIG. 4) is less than the mean of the concurrency variable (e.g., “Avg Conc” in FIG. 4), the compute module can interpret the result as an indication that the system or process being monitored is not experiencing abnormally high concurrency. Thus, no anomaly is detected with respect to the concurrency variable. Alternatively, if the compute module determines that the performance of the concurrency variable is not abnormal (i.e., the absolute value of the deviation of concurrency is less than the predefined threshold), the compute module can interpret the result as an indication that no anomaly is detected with respect to the concurrency variable. Thus, the method 500 returns to step 504 to collect and process next observation of the concurrency variable.

If the compute module determines that the current value of the concurrency variable is greater than or equal to the mean of the concurrency variable, and the performance of the concurrency variable is abnormal (i.e., the absolute value of the deviation of concurrency is greater than or equal to the predefined threshold), the compute module can interpret the result as an indication that the system or process being monitored is experiencing abnormally high concurrency. For example, in FIG. 4, “Conc HighLim” represents a variable (e.g., a binary variable, a flag) that indicates whether the concurrency is abnormally high. Then the compute module proceeds to step 512 to determine whether the system or process has a recent history of stable throughput.

At 512, the compute module can calculate a stableness variable indicating stableness of the throughput variable by dividing the variance (e.g., EWMV) of the throughput variable by the mean (e.g., EWMA) of the throughput variable. For example, in FIG. 4, “Tput IOD” represents such a stableness variable indicating the stableness of the throughput variable.

At 514, the stableness variable calculated at 512 can be compared with a predefined threshold (e.g., 335). Such a comparison can be performed at the compute module (e.g., the compute module 140 in FIG. 1) or the decision module (e.g., the decision module 150 in FIG. 1) of the detection device. If the detection device determines that the stableness variable is greater than the predefined threshold, the detection device can interpret the result as an indication that the system or process being monitored does not have a recent history of stable throughput. In other words, the system or process is not stable enough to generate a baseline of normal behavior. Thus, a fault is not determined in such a scenario. As shown in FIG. 5, the method 500 then returns to step 504 to collect and process next observation of the throughput variable. If the detection device determines that the stableness variable is less than or equal to the predefined threshold, the detection device can interpret the result as an indication that the system or process being monitored has a recent history of stable throughput. Thus, a fault can be detected (e.g., at the decision module of the detection device) for the system or process being monitored, and the detection result can be reported to, for example, a user (e.g., the user 170 in FIG. 1) of the detection device. In some embodiments, the threshold for determining stability of the throughput can be calibrated (e.g., by a user of the detection device) to enable (by increasing the threshold) or suppress (by decreasing the threshold) fault detection for different variables.

Although described with respect to FIGS. 5-6 as the methods 500, 600 being primarily executed at the compute module of the detection device, in some other embodiments, a portion of the operations in the method 500 or 600 can be performed by other modules (e.g., the decision module) of the detection device. For example, as shown in FIGS. 1 and 4, various data or information associated with the detection process 400 can be provided to the decision module 150 of the detection device 100, where a final decision-making process 450 can be executed to generate a detection decision. Specifically, the decision module 150 can receive counter values from the counter module 160; observation data (e.g., “Throughput” and “Concurrency”) from the data collection module 130; calculated results (e.g., “Tput LowLim”, “Conc HighLim” and “Tput IOD”) from the compute module 140, and/or the like.

In some instances, for example, a fault of a system or process can be defined based on an accumulation of inventory or backlog in the system or process. A system or process that is requested to perform work can satisfy the demand by completing the work units and generating throughput. If the demand is satisfied quickly, the work-in-process can be low, and the backlog or inventory can be correspondingly low. The backlog or inventory can be measured by the concurrency variable, as defined above. In some instances, such a concurrency variable can be referred to as, for example, load, load average, run queue, and/or the like.

In some instances, increasing demand can result in increasing concurrency. Increasing concurrency, however, does not necessarily indicate a fault in the system or process. For example, a well-functioning system or process can respond to increased demand with a corresponding increase in throughput. Thus, if concurrency increases and throughput also increases correspondingly, the system or process can experience increased demand, and respond to the increased demand appropriately. In such scenarios, abnormal behavior (e.g., abnormally high throughput and/or concurrency) of the system or process can be external to the system or process, on which the detection method (e.g., the method 500) is applied. Similarly, in some instances, if throughput and concurrency of the system or process are abnormally low, abnormality can exist within a system or process that is generating the demand, thus external to the system or process on which the detection method is applied. Additionally, in some instances, if throughput is abnormally high (e.g., above a threshold) and concurrency is abnormally low (e.g., below a threshold) in a system or process, the system or process can experience increased demand for abnormally small or short units of work, which typically does not constitute a fault within the system or process because the demand can be satisfied quickly.

In some instances, if throughput is abnormally low (e.g., below a threshold) and concurrency is abnormally high (e.g., above a threshold) in a system or process, then the system or process may be unable to complete its backlog by processing units of work in the expected time. Specifically, the system or process may fail to respond appropriately to increased demand. Thus, an internal fault can exist within the system or process. In some instances, a fault of a system or process can be, for example, a failure in a portion of the system or process (e.g., a remote procedure call, a disk input/output (I/O) operation) that is delegated. Additionally, the thresholds used above can be configured, for example, by a user of the detection method to detect the situation of abnormally low throughput and abnormally high concurrency.

FIG. 7 is a diagram illustrating results of performing a detection method (e.g., the method 300 shown and described with respect to FIG. 5) for a system or process, according to an embodiment. Specifically, the diagram illustrates a throughput variable 720 and a concurrency variable 740 of the system or process changing with time (e.g., represented by the X-axis). Although shown as continuous curves in FIG. 7, in some embodiments, the curve for the throughput variable 720 or the concurrency variable 740 can be generated based on a set of observations of the corresponding variable that are collected from the system or process at different times. The detection method can be applied to detect internal faults for the system or process based on the results shown in FIG. 7. For example, the detection method can be used to detect an abnormally low throughput and an abnormally high concurrency that occur substantially simultaneously at the time 750 (identified by the vertical line in FIG. 7). As described above, such a situation can indicate an internal fault of the system or process. Thus, the detection method can determine that an internal fault of the system or process occurs at the time 750.

In some embodiments (not shown), the detection device 100 can be configured to employ multiple approaches to determine whether the host device 190 is operating with fault. In some embodiments, at least one of the multiple approaches can be based on observation of one or more variables. In some embodiments, at least one of the multiple approaches can be carried out as substantially described herein (e.g., executed by the detection device 100, and/or by any of the methods 200, 300, 500, 600).

In some embodiments, each approach from the multiple approaches can indicate whether the host device 190 is operating with a fault or not, such that multiple indications are obtained. In such embodiments, a decision process based on the multiple indications can be used to determine whether the host device 190 is operating with a fault. In some embodiments, the decision process can be a consensus, a majority-vote, and/or combinations of the multiple indications.

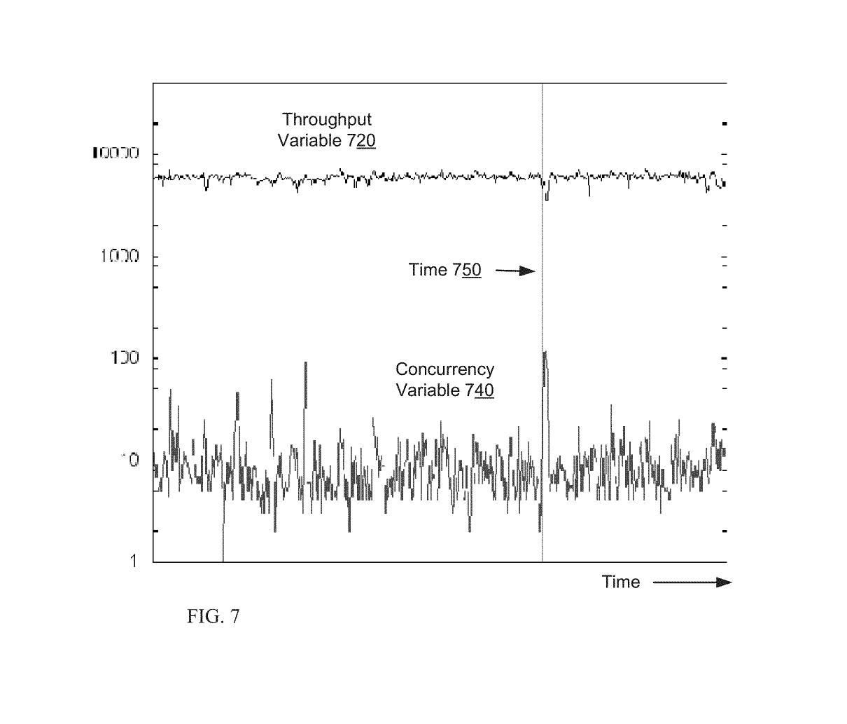

FIG. 8 illustrates an embodiment in which multiple detection devices 800a, 800b, 800c . . . 800n can be configured to observe operation of a host device 890. In some instances, the detection devices 800a-800n can be structurally and/or functionally similar to the detection device 100, and are also sometimes referred to as a set of detection devices. In other instances, the functionality associated with each of the detection devices 800a-800n as described herein can be performed by a corresponding set of modules (e.g., a set of modules that includes, similar to FIG. 1, a data collection module, a compute module, a counter module, and a decision module); in this manner, multiple sets of modules running on a single detection device can be functionally similar to the detection devices 800a-800n. Any combination of the group device 812, the detection devices 800a-800n, and/or the host device 890 can form part of, or be associated with, a network.

In some instances, each detection device (e.g., the detection device 800a, for simplicity) can include a memory (e.g., the memory 180) and/or a database (not shown) that stores an observation value for a variable, where the observation value is associated with operation of the host device 890 at a given time. Each detection device can also include a processor (e.g., the processor 110) operatively coupled to the memory/database and configured to analyze the observation value based on a criterion to generate an outcome such as, for example, whether the host device is operating with or without fault. In some instances, the criterion (also sometimes referred to as a first criterion) is associated with a criterion value (also sometimes referred to as a first criterion value) such as, for example, a threshold value. In some instances, the criterion value associated with that detection device (e.g., the detection device 800a) is different than a criterion value associated with each other detection device (e.g., the detection devices 800b-800n). In this manner, each detection device can evaluate/monitor the performance of the host device a bit differently than the rest, provided varied analysis to the group device 812.

In some instances, at least one of the detection devices (e.g., the detection device 800a) can be configured differently than at least one other detection device (e.g., the detection device 800c). In some instances, the number of the detection devices 800a-800n is based on a set of permissible values for the criterion value. For example, if the criterion value can be integral values ranging from 1 to 10, then ten detection devices can be employed, with the first detection device associated with a criterion value of 1, a second detection device associated with a criterion value of 2, and so on. Said another way, at least one of the detection devices 800a-800n can employ criterion, threshold, and/or other analytical parameters (hereafter, collectively “parameters”) different from at least one other detection device 800a-800n. For example, at least one of the detection devices 800a-800n can employ a different threshold value for the standard deviation when calculating the deviation value than a threshold value employed by at least one other detection device 800a-800n. As another example, at least one of the detection devices 800a-800n can employ a different predetermined number of observations for the variable received prior to calculating the deviation value than a predetermined number of observations employed by at least one other detection device 800a-800n. As another example, at least one of the detection devices 800a-800n can employ a different criterion/threshold for the observation value than an observation value employed by at least one other detection device 800a-800n. As yet another example, at least one of the detection devices 800a-800n can employ a different criterion/threshold for the deviation value than the criterion/threshold employed by at least one other detection device 800a-800n. As another example, at least one of the detection devices 800a-800n can employ a different criterion/threshold for the stableness value than the criterion/threshold employed by at least one other detection device 800a-800n. As another example, at least one of the detection devices 800a-800n can determine that the host device 890 is operating with a fault when the deviation value meets a criterion that is different than such a criterion used by at least one other detection device 800a-800n. As yet another example, at least one of the detection devices 800a-800n can employ an approach for baseline value computation (e.g., EWMA) that is different than an approach (e.g., double EWMA) employed by at least one other detection device 800a-800n.

In some instances, as described with respect to FIGS. 1-7, the processor of each detection device (e.g., the detection device 800a) is further configured to analyze the observation value by determining that a predetermined number of observations for the variable has been received prior to the time, and computing a deviation value for the variable from a baseline value based on the observation value and based on the predetermined number of observations. The processor for that detection device can be further configured to generate the outcome as an indication that the host device is operating with a fault at the time in response to the deviation value meeting the first criterion and the observation value meeting another criterion (sometimes also referred to as a second criterion). In some instances, the deviation value of the variable meets the first criterion if the deviation value of the variable is greater than or equal to the normalcy threshold for the variable.

In some instances, as described with respect to FIGS. 1-7, the processor of each detection device is further configured to analyze the observation value by computing a deviation value for the variable from a baseline value at the time based on the observation value. The processor of that detection device is further configured for computing, after receiving a predetermined number of observation values of the variable, a stableness value of the variable at the time based on the baseline value and a variance of the variable during a time period including the time. The processor of that detection device is further configured to generate the outcome as an indication that the host device is operating with a fault at the time in response to the deviation value meeting the first criterion and the stableness value meeting another criterion (sometimes also referred to as a second criterion). In such instances, the first criterion can be based on the baseline value.

In some instances, as described with respect to FIGS. 1-7, the processor of each detection device is further configured to analyze the observation value by computing a deviation value of the variable from a baseline value at the time based on the observation value, and by computing, after receiving a predetermined number of observation values of the variable, a stableness value of the variable at the time based on the baseline value and a variance of the variable during a time period that includes the time. The processor of that detection device is further configured to generate the outcome as an indication that the host device is operating with a fault at the time in response to the stableness value meeting the first criterion and the deviation value meeting another criterion (sometimes also referred to as a second criterion). In some instances, the stableness value of the variable meets the first criterion if the stableness value is less than a stability threshold.

In some instances, each of detection devices (e.g., the detection device 800a) can be configured differently than every other detection device (e.g., the detection device 800c). In some instances, the number of detection devices 800a-800n can be based on the number of possible permutations of the possible values of at least one analytical parameter. For example, if the threshold for the observation value can vary from 1 to 10 in increments of 1, then ten detection devices can be employed, with one detection device operating at a threshold value of 1, the next operating at a threshold value of 2, and so on.

For example, in some instances, the processor of each detection device is further configured to analyze the observation value based on a second criterion associated with that detection device, where the second criterion is different from the first criterion. The second criterion is associated with a second criterion value that is unique to that detection device. Said another way, the second criterion value associated with each detection device is different than the second criterion value associated with other detection devices. In such instances, the number of detection devices 800a-800n can be based on the permissible permutations of the first criterion value and the second criterion value. In some instances, the threshold value(s) for each of the detection devices 800a-800n can be specified in any suitable manner, including in a random manner (e.g., by the group device 812), manually, dynamically, and/or the like. In some instances, the threshold value(s) for each of the detection devices 800a-800n can be specified and/or updated via machine learning approaches such as, but not limited to, decision trees, neural networks, clustering, and/or the like. In some embodiments, the number of detection devices 800a-800n can be based on the number of possible permutations of all possible criterion values of multiple criterion/analytical parameters. In some embodiments, the number of criterion can be one, two, three, four, five, six, seven, eight, nine, ten, or more than ten, and the number of detection devices 800a-800n can be based on the number of possible permutations of criterion values associated with those criteria.

As also illustrated in FIG. 8, a group device/system 812 is communicably coupled to the detection devices 800a-800n.

The group device 812 can include for example at least a processor and a memory (not shown) coupled to the processor. The processor of the group device 812 can be configured to receive a set of outcomes from the detection devices 800a-800n, where each outcome is associated with and unique to one of the detection devices. For example, in some instances, the group device 812 receives, from each of the detection devices 800a-800n, an indication of whether the host device 890 is operating with a fault. The processor of the group device 812 can be further configured to compute an indication of a state of the host device 890 as operating with or without fault based on the set of outcomes. In some instances, the processor of the group device 812 computes an indication of the host device 890 as operating with fault when a predetermined number of the criterion values (e.g., at least five or more criterion values) received from the detection devices 800a-800n indicate the host device 890 as operating with fault. In some instances, the processor of the group device 812 computes an indication of the host device 890 as operating with fault when at least one criterion value received from the detection devices 800a-800n indicates the host device 890 as operating with fault. In some instances, the processor of the group device 812 computes an indication of the host device 890 as operating with fault when each criterion value received from the detection devices 800a-800n indicates the host device 890 as operating with fault.

By way of examples, in some instances, the group device 812 is configured to (e.g., includes one or more modules configured to), based on the indications from the detection devices 800a-800n, deem the host device 890 as operating with or without fault based on any suitable approach(es) and based on the signals/indications received from the detection devices 800a-800n. In some instances, one such approach is a majority decision; i.e., if a majority of the detection devices 800a-800n indicate that the host device 890 is not operating with fault (i.e., operating normally), then the group device 812 will deem the host device 890 as operating normally. Moreover, in such instances, if a majority of the detection devices 800a-800n indicate that the host device 890 is operating with a fault, the group device 812 can deem the host device as operating with a fault. In other instances, the group device 812 can deem the host device 890 as operating with a fault if each of the detection devices 800a-800n deems and/or indicates that the host device 890 is operating with a fault. Otherwise, the group device 812 can determine the host device 890 is operating normally. In still other instances, the group device 812 deems the host device 890 as operating with a fault when a predetermined number of the detection devices 800a-800n provide such an indication. In yet other instances, the group device 812 deems the host device 890 is operating with fault when a single detection device 800a-800n provides such an indication. In still other instances, the group device 812 can be configured to include any suitable additional approaches to identify a fault. The processor of the group device 812 can be further configured to transmit the indication of the state of the host device over the network, such as to, for example, the host device 890, a device associated with an administrator of the host device, and/or the like.

Aspects of the group device 812 and/or the detection devices 800a-800n can be, for example, configured for reliable fault detection in the host device 890. Still referring to FIG. 8, in some instances, each detection device 800a-800n is configured to evaluate a reliability measure, and if the reliability measure does not meet a reliability criterion (e.g., does not exceed a reliability threshold for that detection device 800a-800n), the detection device 800a-800n is configured to stop contributing to the fault determination for the host device 890. In some instances, the detection device employs the stableness value, or a derived value thereof, as the reliability measure.

In other instances, the detection devices 800a-800n of FIG. 8 use and/or employ the deviation value, or a derived value thereof, as the reliability measure, with the reliability threshold being the normalcy threshold. Said another way, in some instances, the processor of each detection device can be configured to compute a deviation value of the variable from a baseline value at the time based on the observation value, and compute a reliability measure based on the deviation value. The reliability measure includes (1) an indication of that detection device as being reliable if the deviation value of the variable is greater than or equal to a normalcy threshold for the variable, and (2) an indication of that detection device as being unreliable if the deviation value of the variable is less than the normalcy threshold for the variable. An indication of the reliability measure is then transmitted to the group device, and a processor of the group device is further configured to, upon receiving the indication of the reliability measure from each detection device, deem a particular detection device as reliable based on the reliability measure of that detection device. The processor of the group device can be further configured to compute the indication of the state of the host device based at least in part on the outcome (e.g., fault or no fault) that is associated with the detection device that is deemed as reliable.

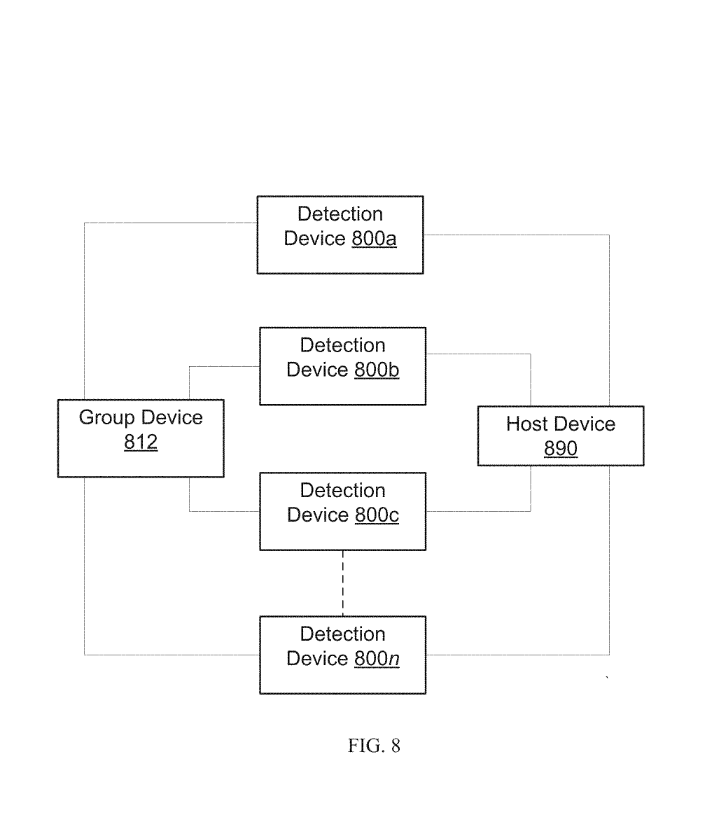

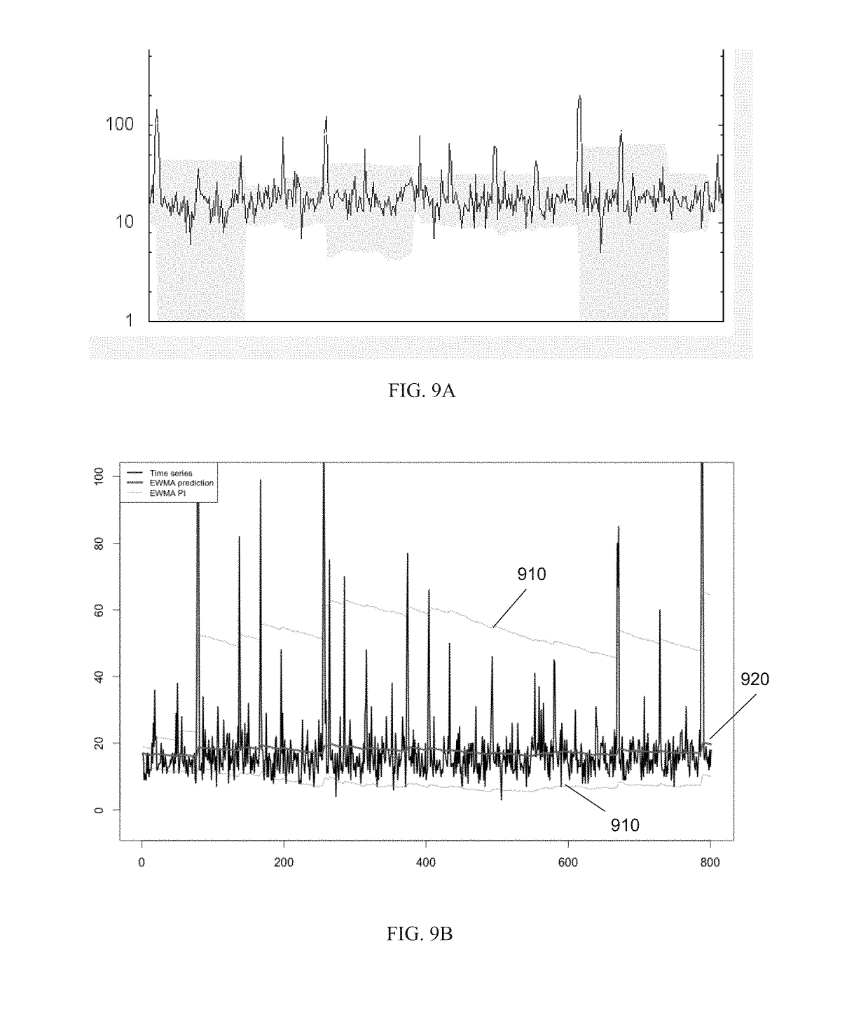

In some instances, the normalcy threshold is a combination of multiple thresholds derived from the deviation value based on the deviation value, or a derived value thereof, and the observation value, or a derived value thereof. For example, in some instances, the normalcy threshold includes an upper limit and a lower limit to define an interval of the normalcy threshold. The upper limit can both be based on the EWMA of the deviation value, and a standard deviation of the EWMA. Said another way, in some instances, the processor of each detection device can be configured to compute a deviation value of the variable from a baseline value at the time based on the observation value. The processor of that detection device can be further configured to compute an upper limit for the deviation value based on an EWMA of the deviation value, and to compute a lower limit for the deviation value based on the EWMA of the deviation value. The processor of that detection device can be further configured to compute a normalcy range for the variable based on the upper limit for the deviation value and the lower limit for the deviation value. The processor of that detection device can be further configured to compute a reliability measure based on the deviation value. The reliability measure includes (1) an indication of that detection device as being reliable if the deviation value of the variable is within the normalcy range for the variable, and (2) an indication of that detection device as being unreliable if the deviation value of the variable is outside the normalcy range for the variable. An indication of the reliability measure is then transmitted to the group device, and a processor of the group device is further configured to, upon receiving the indication of the reliability measure from each detection device, for each detection device, deem that detection device from the set of detection devices as reliable or unreliable based on the reliability measure of that detection device. The processor of the group device is further configured to compute the indication of the state of the host device based at least in part on the outcome of each detection device from the set of detection devices identified as reliable. FIG. 9A illustrates normalcy thresholds (shaded areas) with upper and lower limits for an example signal.

In some instances, the detection devices 800a-800n are configured to calculate an upper EWMA of the deviation value (i.e., an EWMA based on deviation values that are greater than an estimate thereof) and a lower EWMA of the deviation value (i.e., an EWMA based on deviation values that are lower than an estimate thereof). The detection device can be further configured to calculate a combined EWMA as a sum of its upper EWMA and lower EWMA. In such instances, an upper limit of the normalcy threshold can be based on the combined EWMA and a standard deviation of the upper EWMA, and a lower limit of the normalcy threshold can be based on the combined EWMA and a standard deviation of the lower EWMA. FIG. 9B illustrates normalcy thresholds (shaded areas) with upper and lower limits for an example signal when using upper and lower EWMAs. FIG. 9B illustrates normalcy thresholds (thin lines labeled “EWMA PI” 910) with upper and lower limits for an example signal (and an estimated “Prediction EWMA” 920) when using upper and lower EWMAs.

In some instances, a detection device is configured to calculate a reliability measure based on a ratio of deviation values that fall within a normalcy threshold and deviation values that exceed the normalcy threshold. In some instances, the reliability measure is based on an EWMA of the ratio of deviation values that fall within the normalcy threshold and deviation values that exceed the normalcy threshold. In such instances, when the EWMA of the ratio is within the reliability threshold, the detection device can deem its fault determination to be reliable, and when the EWMA of the ratio exceeds the reliability threshold, the detection device can deem its fault determination to be unreliable. In some instances, the reliability measure is an EWMA of a variable that is either 1 when the deviation value is within the reliability threshold, or 0 when the deviation value is greater than the threshold. In such instances, the reliability measure is effectively a number between 0 and 1. Also, in such instances, once the reliability measure is calculated, the reliability measure can be modified for each subsequent deviation value based on a decay factor, such that when the subsequent deviation value is within the reliability threshold, the reliability measure is increased based on the decay factor, and when the subsequent deviation value exceeds the reliability threshold, the reliability measure is decreased based on the decay factor. For example, the reliability measure can include a numerical indication, say 0.8, that sets a lower threshold for the ratio of deviation values that fall within a normalcy threshold and deviation values that exceed the normalcy threshold. In this example, if the ratio exceeds 0.8, the detection device can deem its fault determination to be reliable, and if the ratio is less than or equal to 0.8, the detection device can deem its fault determination to be unreliable. In other instances, any other suitable value and/or criterion can be used to compare such a ratio.

In some instances, the detection device, upon determining itself to be unreliable, stops contributing to the fault determination by ceasing to provide its fault determination to the group device 812. In some instances, the detection device stops contributing to the fault determination by communicating an indication to the group device 812 to ignore its fault determination, until another indication of reliability is provided.

In some instances, the group device 812 is configured to evaluate a reliability measure for each of the detection device 800a-800n, and if the reliability measure for a particular detection device does not meet a reliability criterion (e.g., does not exceed a reliability threshold), then the particular detection device is deemed unreliable, and its fault determination is not taken into account by the group device 812. In some instances, the processor of each detection device is further configured to compute an estimated observation value associated with the observation value described herein (sometimes also referred to as an “actual” observation value), and transmit indications of the actual and estimated observation values to the group device 812. The processor of the group device 812, upon receiving the indication of the estimated observation value and the indication of the actual observation value from each detection device, can be further configured to, for each detection device, compute an error between the estimated observation value and the actual observation value for that detection device, and then deem that detection device as reliable when the error meets a reliability criterion. In some instances, the processor of the group device 812, upon receive the indication of the estimated observation value and the indication of the actual observation value from each detection device, can be further configured to, for each detection device, compute an exponentially weighted moving average (EWMA) of an error between the estimated observation value and the actual observation value for that detection device. The processor of the group device 812 can then deem that detection device as reliable when the EWMA of the error meets a reliability criterion.

In some instances, the processor of the group device 812, upon receiving the indication of the estimated observation value and the indication of the actual observation value from each detection device, can be further configured to, for each detection device, compute an exponentially weighted moving average (EWMA) of an error between the estimated observation value and the actual observation value for that detection device. In this manner, a set of EWMA of errors associated with the detection devices 800a-800n are generated by the group device 812. The processor of the group device 812 can then be configured to identify the state of the host device 890 based on the outcome associated with the detection device having the lowest EWMA of error from the set of EWMA of errors. For example, if the detection device 800a deems the host device as operating without fault and has the lowest EWMA amongst all detection devices, then the group device 812 will also deem the host device as operating without fault. In another instance, once the set of EWMA of errors is generated, the processor of the group device 812 can be further configured to compute, for each detection device from the set of detection devices, a weighted outcome based on the outcome for that detection device weighted by the EWMA of error for that detection device. In this manner, a set of weighted outcomes is generated corresponding to the detection devices 800a-800n. The processor of the group device 812 can then compute the state of the host device 812 based on the set of weighted outcomes.

For example, in some instances, the group device 812 receives, from each detection device 800a-800n, a) an indication of the observation value, and b) an indication of an estimate of the observation value. In other instances, the group device 812 receives, from each detection device 800a-800n, an indication of the observation value, and is configured to generate and/or calculate the indication of the estimate of the observation value in any suitable manner. For example, in some instances, the group device 812 is configured to calculate the estimate of the observation value based on an EWMA and/or a group EWMA of past observation values. As another example, in some instance, the group device 812 is configured to calculate the estimate of the observation value based on statistical approaches such as, but not limited to, Maximum likelihood estimation, Bayes estimation, Kalman filters, Monte Carlo modeling, and/or the like.

The group device 812 can be configured to calculate, for the specific detection device, an error between the observation value, and the estimate thereof. In some instances, the group device 812 is configured to calculate a single EWMA of the error by combining a set of EWMAs received from a detection device. The set of EWMAs can be based on the observation values. For example, each detection device 800a-800n can be configured to generate two EWMAs, including a first EWMA for errors where the observation value is greater than the estimate, and a second EWMA for errors where the observation value is lower than the estimate. The group device 812 can be configured to receive the first EWMA and the second EWMA and, if the observation value is greater than the estimate, generate/update an upper EWMA of the error for the detection device based on the difference between the observation value and the estimate, and based on the previous upper EWMA of the error for the detection device. If the observation value is less than the estimate, the group device 812 can be configured to generate/update a lower EWMA of the error for the detection device. The group device 812 is further configured to combine the upper EWMA of the error and the lower EWMA of the error to calculate the single EWMA of the error, which can then be compared to a reliability measure as described herein.

In some instances, the group device 812 is configured to calculate an EWMA of the error between the observation value and the estimate thereof as the reliability measure of the specific detection device. If the EWMA of the error is within the reliability threshold (e.g., meets a reliability criterion), the group device 812 can deem the fault determination of the specific detection device to be reliable. When the EWMA of the error exceeds the reliability threshold (e.g., does not meet a reliability criterion), the group device 812 can deem the fault determination of the specific detection device to be unreliable. In this manner, when the detection devices 800a-800n are each operating with different analytical parameters, those detection devices operating with parameters more likely to provide an accurate estimate of a future observation value are less likely to be deemed unreliable, and vice versa.

In some instances, the group device 812 is configured to deem the detection device(s) with the lowest value for the EWMA of the error to be the most reliable and deem the fault determination of that detection device(s) with the lowest value for the EWMA of the error to be its own fault determination for the host device 890. In this manner, the detection device that has historically been the most accurate at predicting normal behavior of the host device 890 is deemed to be the source of fault determination information, and can singularly indicate that the host device 890 is operating with fault. In some instances, the group device 812 is configured to dynamically determine a number of detection device(s) to be used for fault determination, based on the reliability of each detection device. In some instances, for example, the group device 812 is configured to weigh the fault determination of each detection device, based on the reliability of each detection device. In some instances, the group device 812 is configured to calculate or assign a weighted sum of the reliability of each detection device, with the highest weight given to the most reliable detection device, and the lowest weight given to the least reliable detection device. The group device 812 can be further configured to compare the weighted sum against a threshold and, if the weighted sum exceeds the threshold, deem the host device 890 as operating without fault, and operating with fault if the weighted sum does not exceed the threshold.

In some instances, the group device 812 is configured to deem the host device as operating with fault based on two or more variables. For example, in some instances, a first set of detection devices (e.g., detection devices 800a, 800b) are configured for fault detection as disclosed herein for a first variable, and a second set of detection devices (e.g., the detection device 800c) are configured for fault detection as disclosed herein for a second variable. As an example, one of the first variable and the second variable can be a measure of throughput of a database for the host device 890, and the other of the first variable and the second variable can be a measure of concurrency for the database of the host device 890. In some instances, the group device 812, upon deeming the host device 890 as operating with a fault with respect to both the first variable and the second variable, is further configured to compute an indication of a severity of the fault as follows. In some instances, a first score for the detection device of the first set of detection devices having the lowest EWMA of error among the first set of detection devices is calculated. In some instances, the first score is based on the absolute difference between the actual observation value for the first variable and the EWMA of the observation values for the first variable. The first score can be indicative of to what extent the observation value deviates from historical observation values for the first variable.

In some instances, a second score for the detection device of the second set of detection devices having the lowest EWMA of error among the second set of detection devices is calculated. In some instances, the second score is based on the absolute difference between the actual observation value for the second variable and the EWMA of the observation values for the second variable. The second score can be indicative of to what extent the observation value deviates from historical observation values for the second variable. As an example, the first score and the second score can be calculated as:

First_score=Abs(Obs_{V1}−EWMA_{V1})/sqrt(EWMAerror_{V1})

Second_score=Abs(Obs_{V2}−EWMA_{V2})/sqrt(EWMAerror_{V2})

where Abs=absolute value operator; Obs_{V1}=actual observation value for the first variable from that detection device of the first set of detection devices; EWMA_{V1}=EWMA for the observation value for the first variable; sqrt=square root operator; EWMAerror_{V1}=EWMA of the error for the observation value for the first variable; Obs_{V2}=actual observation value for the second variable from that detection device of the first set of detection devices; EWMA_{V2}=EWMA for the observation value for the second variable; EWMAerror_{V2}=EWMA of the error for the observation value for the second variable.

It is understood that while computation of first and second scores, associated with the first variable and second variable, respectively, are described herein, any suitable number of scores for any suitable number of variables can be computed. For example, in some embodiments, a third score associated with a third variable, and/or additional scores based on additional variables, can be computed.

In some instances, the group device 812 can be further configured to compute the indication of severity of the fault (e.g., a “severity score”) based on any suitable arithmetic combination of the first score and the second score. In some instances, the severity score can be computed as the sum of the first score and the second score. In some instances the severity score can be computed based on the first score, the second score, a third score, and/or additional scores.

In some instances, the group device 812 can be further configured to compare the severity score against a predetermined criterion (e.g., a predetermined threshold and/or a predetermined range of values). In some instances, if the severity score doesn't meet the criterion (e.g., is lower than the predetermined threshold), the group device 812 is configured to take no remedial action. For example, if the severity score doesn't meet the criterion, the group device 812 can be configured to transmit an indication of the host device 890 as operating without fault, or to transmit an indication of the host device 890 as operating with fault with respect to one or more variables but not operating with fault overall, and/or the like. In this manner, even if the host device 890 is faulting in some aspects (i.e., for some variables) but not for others, it may still be permitted to continue operation without intervention and/or notification. Example values for a threshold for the severity score can include, but are not limited to absolute values (e.g., 2.0, 4.0, 6.0, 10.0, and/or the like) or values based on a distribution (e.g., within 3 standard deviations of a distribution of values for a predetermined variable).

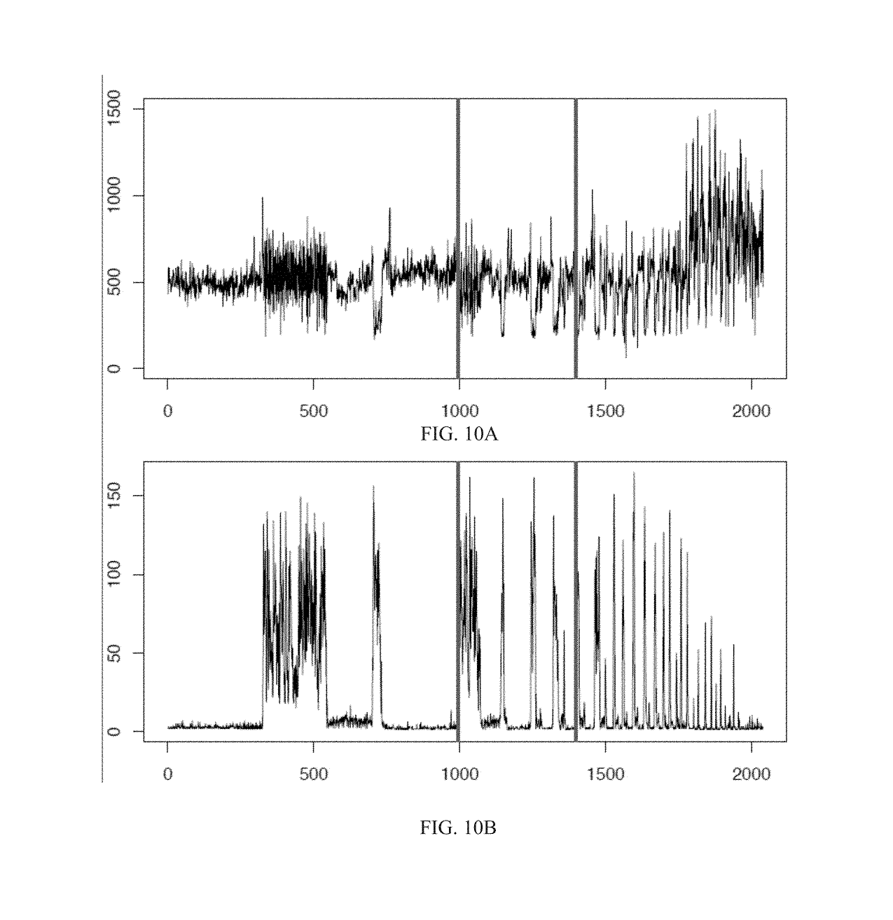

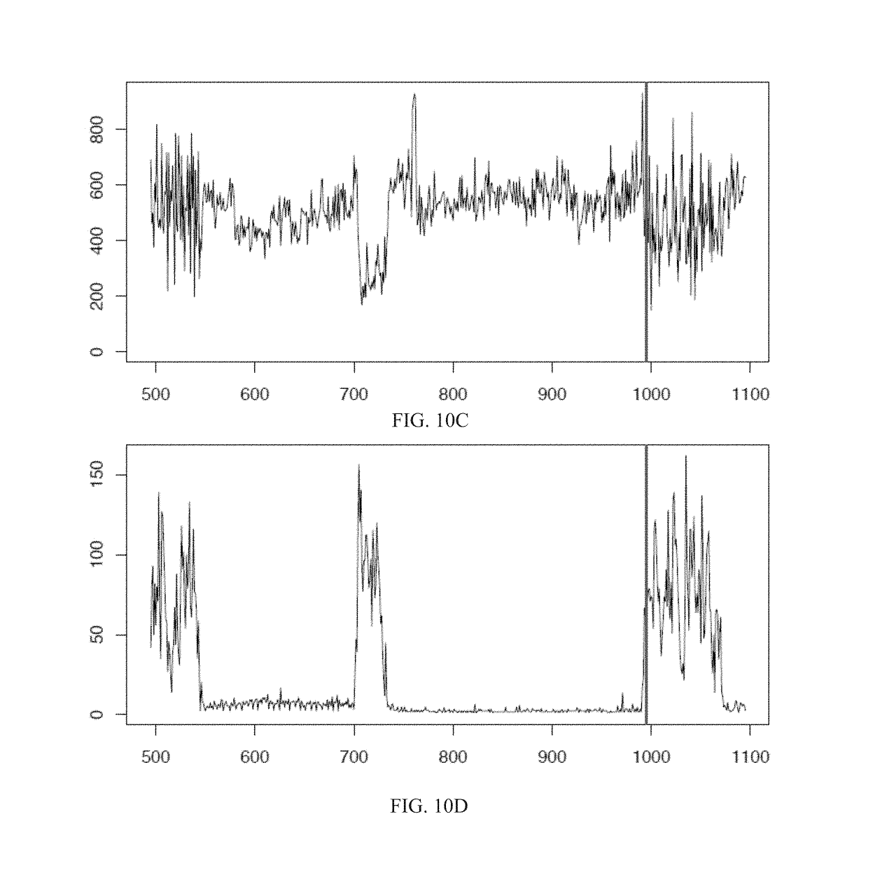

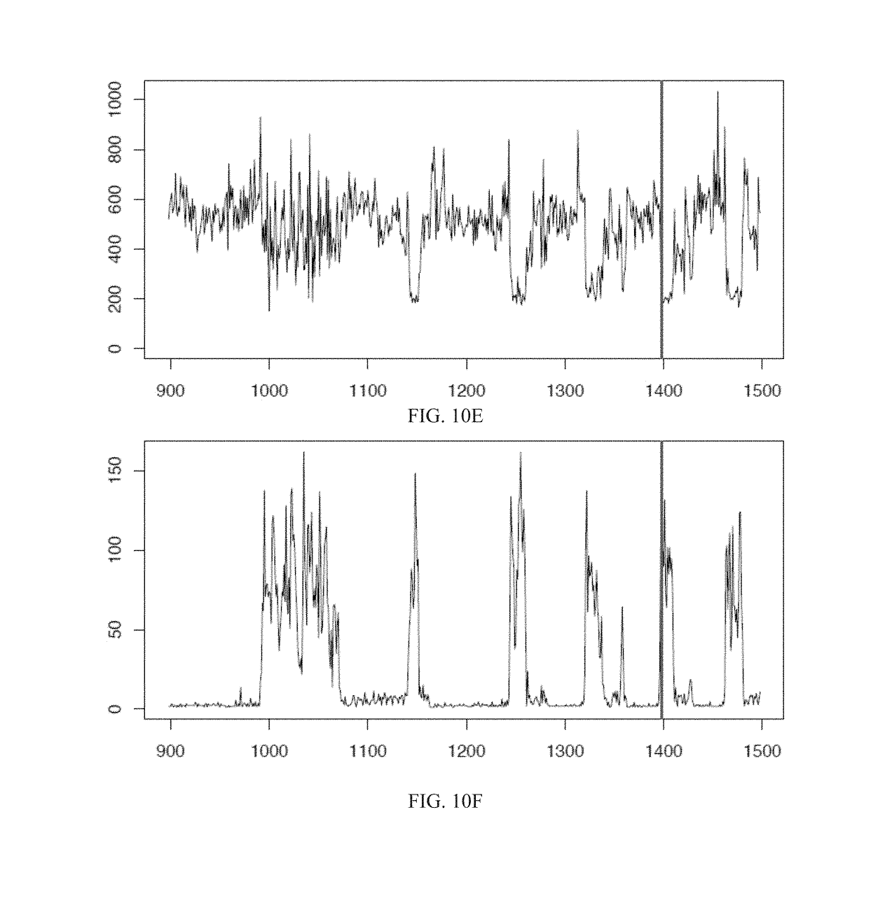

FIGS. 10A-10F illustrate example fault detection in a first set of observation values for throughput of a host device (FIGS. 10A, 10C, 10E), and a second set of observation values for concurrency of operation of the host device (FIGS. 10B, 10D, 10F) when using a double EWMA approach, with the vertical lines indicating where two faults, readily visible to the naked eye, are detected. FIGS. 10A, 10B illustrates a time range from 0-2000 time units (e.g., seconds, for simplicity), with faults detected around 1000 s, 1400 s in both sets (as illustrated by vertical reference lines). The faults in FIG. 10A illustrate abnormally low throughput, and the faults in FIG. 10B illustrate abnormally high concurrency. FIGS. 10C, 10D are magnified views of the first fault (at 1000 s) in the first and second set of observation values, respectively. FIGS. 10E, 10F are magnified views of the second fault (at 1400 s) in the first and second set of observation values, respectively. In this manner, employing double EWMA can permit a detection device to be more likely to reliably detect the faults at 1000 s, 1400 s.

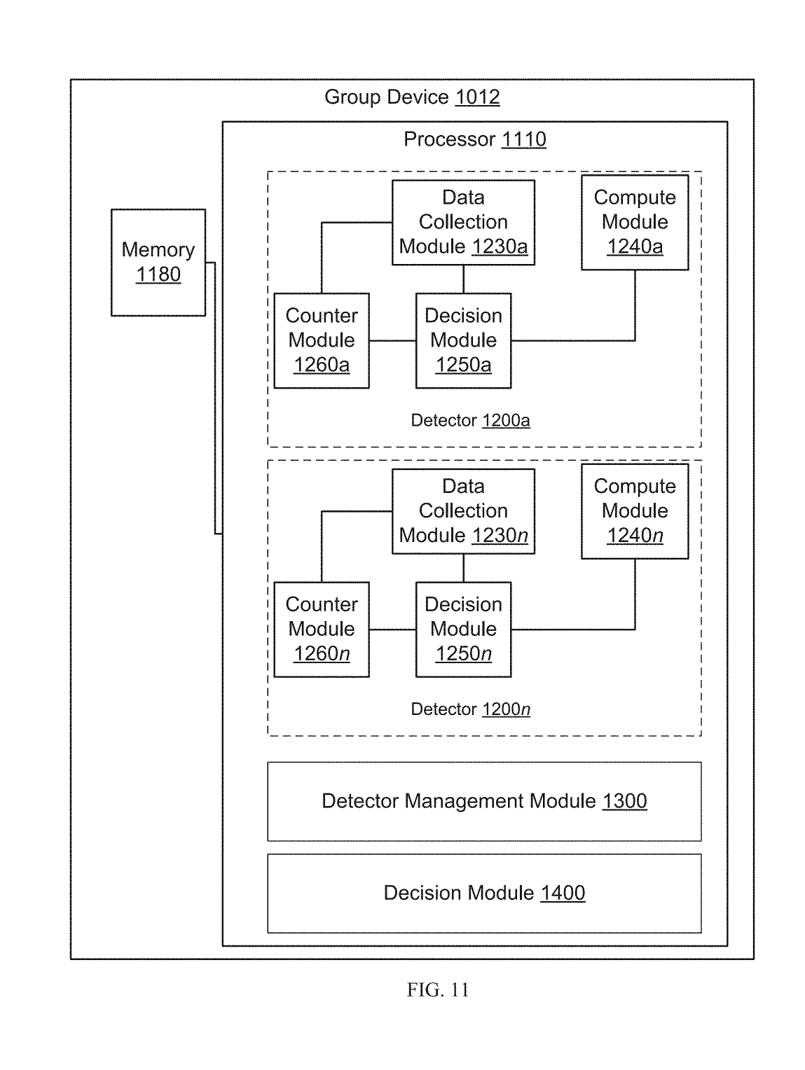

FIG. 11 illustrates an embodiment of a group device 1012 configured for performing the combined functionality of the group device 812 and the detection devices 800a-800n within a single device, according to another embodiment. The group device 1012 includes a processor 1110 and a memory 1180 connected to processor 1110. The processor 1012 includes a set of detectors 1200a-1200n. Each detector can independently include, for example, computer software (stored in and/or executed in hardware (e.g., stored in memory 1180 and executing in processor 1110)) such as web applications, database applications, cache server applications, queue server applications, application programming interfaces (APIs), operating systems, file systems, and/or the like; computer hardware such as network appliances, storage devices (e.g., disk drives, memory modules), processing devices (e.g., computer central processing units (CPUs)), computer graphic processing units (GPUs)), networking devices (e.g., network interface cards), and/or the like; and/or combinations of computer software and hardware.

Each detector 1200a-1200n can be functionally similar to the detection devices shown and described with respect to at least FIGS. 1 and 8. As also illustrated in FIG. 11, each detector 1200a-1200n can include a data collection module 1230a-1230n, a compute module 1240a-1240n, a decision module 1250a-1250n, and a counter module 1260a-1260n, each of which can be functionally and/or structurally similar to similarly named components shown and described with respect to FIG. 1. In some instances, one or more of the detectors 1200a-1200n can be configured for evaluating its own reliability measure, as described with respect to FIG. 8.

The processor 1110 also includes a detector management module 1300 configured to initiate, modify, terminate, and/or delete each of the detectors 1200a-1200n independently of each other. In some embodiments, the detector management module 1300 is configured to initiate and/or define a number of the detectors 1200a-1200n corresponding to the number of possible permutations of possible values of at least one analytical parameter. In this manner, instead of the need for multiple detection devices, a single group device can be employed that spawns and executes multiple detectors concurrently with substantially the same functionality. In some embodiments, the detector management module 1300 is configured to initiate and/or define a number of the detectors 1200a-1200n based on any suitable factor, including, but not limited to, reliability of existing detectors 1200a-1200n, a random number generator specifying the number of the detectors 1200a-1200n, a specific application of the system and/or host device being monitored by the detectors 1200a-1200n, a risk tolerance of the system and/or host device being monitored by the detectors 1200a-1200n, and/or the like.

The processor 1110 also includes a decision module 1400 configured to receive an indication of fault detection from each of the detectors 1200a-1200n, and based on the received indications, deem the host device (not shown in FIG. 11) to be operating with or without fault using any suitable approach such as majority vote, consensus, and/or the like. In some instances, the decision module 1400 is configured to calculate a reliability measure for one or more of the detectors 1200a-1200n, and deem the host device to be operating with or without fault based on the reliability measure(s). In some instances, the decision module 1400 is configured to terminate one or more of the detectors 1200a-1200n based on the corresponding reliability measure.

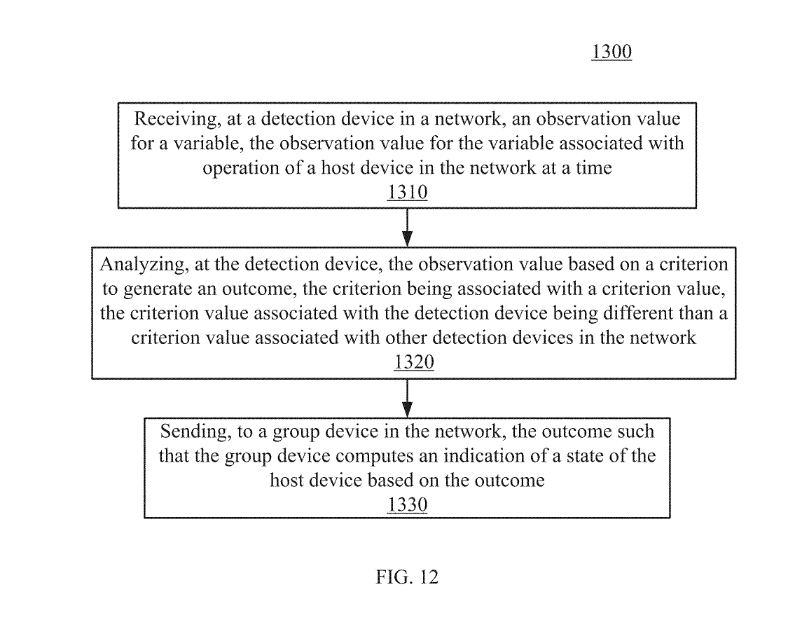

Now referring to operation of a detection device as disclosed herein, FIG. 12 is a flow chart illustrating a method 1300 of outcome determination using a detection device, according to an embodiment. The code representing instructions to perform the method 1300 can be stored in, for example, a non-transitory processor-readable medium (e.g., the memory 180 in FIG. 1) in a detection device that is similar to the detection device 100, any of the detection devices 800a-800n, any of the detectors 1200a-1200n, and/or the like.

Explained with reference to FIG. 8 for simplicity, in some instances, the method 1300 includes, at 1310, receiving, at a detection device (e.g., the detection device 800a) in a network, an observation value for a variable. The observation value is associated with operation of a host device (e.g., the host device 890) in the network at a time.

The method 1300 also includes, at 1320, analyzing, at the detection device, the observation value based on a criterion (sometimes also referred to as a first criterion) to generate an outcome. The criterion is associated with a criterion value. The criterion value associated with that detection device is different than a criterion value associated with other detection devices (e.g., the detection devices 800b-800n) in the network. In some instances, step 1320 further includes, at the detection device, determining that a predetermined number of observations for the variable has been received prior to the time, and computing a deviation value for the variable from a baseline value based on the observation value and based on the predetermined number of observations. The step 1320 can further include generating the outcome as an indication that the host device is operating with a fault at the time in response to the deviation value meeting the first criterion and the observation value meeting a second criterion. The deviation value of the variable can meet the first criterion if the deviation value of the variable is greater than or equal to a normalcy threshold for the variable.

In some instances, a number of detection devices that includes the detection device and other detection devices (e.g., the total number of detection devices for detection devices 800a-800n) is based on a set of permissible values associated with the criterion value. The method 1300 also includes, at 1330, sending, to a group device (e.g., the group device 812) in the network, the outcome such that the group device computes an indication of a state of the host device based on the outcome.

In some instances, the method 1300 further includes, at the detection device, computing a deviation value of the variable from a baseline value at the time based on the observation value, and computing an upper limit for the deviation value based on an EWMA of the deviation value. The method 1300 can further include, at the detection device, computing a lower limit for the deviation value based on the EWMA of the deviation value, and computing a normalcy range for the variable based on the upper limit for the deviation value and the lower limit for the deviation value. The method 1300 can further include, at the detection device, computing a reliability measure based on the deviation value. The reliability measure includes an indication of the detection device as being reliable if the deviation value of the variable is within the normalcy range for the variable, and includes an indication of the detection device as being unreliable if the deviation value of the variable is outside the normalcy range for the variable. The method 1300 can further include deeming the detection device as reliable based on the reliability measure, such that the group device can compute the indication of the state of the host device based at least in part on the outcome of the detection device and based on the detection device being deemed as reliable.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, .NET, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, and not limitation. Where methods and/or schematics described above indicate certain events and/or flow patterns occurring in certain order, the ordering of certain events and/or flow patterns may be modified. While the embodiments have been particularly shown and described, it will be understood that various changes in form and details may be made.

What is claimed is:

1. A system, comprising:
a set of detection devices configured to be communicably coupled to a host device in a network, each detection device from the set of detection devices including:
a database configured to store an observation value for a variable, the observation value for the variable associated with operation of the host device at a time; and
a processor operatively coupled to the database and configured to analyze the observation value based on a criterion to generate an outcome, the criterion being associated with a criterion value, the criterion value associated with that detection device being different than a criterion value associated with each remaining detection device from the set of detection devices; and
a group device configured to be communicably coupled to the set of detection devices via the network, the group device including a processor configured to:
receive a set of outcomes from the set of detection devices, each outcome from the set of outcomes including the outcome being uniquely associated with a detection device from the set of detection devices;
compute an indication of a state of the host device as operating with or without fault based on the set of outcomes; and
transmit, over the network, the indication of the state of the host device.

2. The system of claim 1, wherein the criterion is a first criterion, and the processor of each detection device from the set of detection devices is further configured to analyze the observation value by:
determining that a predetermined number of observations for the variable has been received prior to the time;
computing a deviation value for the variable from a baseline value based on the observation value and based on the predetermined number of observations; and
generating the outcome as an indication that the host device is operating with a fault at the time in response to the deviation value meeting the first criterion and the observation value meeting a second criterion,
the deviation value of the variable meeting the first criterion if the deviation value of the variable is greater than or equal to a normalcy threshold for the variable.

3. The system of claim 1, wherein the criterion is a first criterion, and the processor of each detection device from the set of detection devices is further configured to analyze the observation value by:
computing a deviation value for the variable from a baseline value at the time based on the observation value; and
computing, after receiving a predetermined number of observation values of the variable, a stableness value of the variable at the time based on the baseline value and a variance of the variable during a time period including the time; and
generating the outcome as an indication that the host device is operating with a fault at the time in response to the deviation value meeting the first criterion and the stableness value meeting a second criterion,
the first criterion based on the baseline value.

4. The system of claim 1, wherein the criterion is a first criterion, and the processor of each detection device from the set of detection devices is further configured to analyze the observation value by:
computing a deviation value of the variable from a baseline value at the time based on the observation value;
computing, after receiving a predetermined number of observation values of the variable, a stableness value of the variable at the time based on the baseline value and a variance of the variable during a time period including the time; and
generating the outcome as an indication that the host device is operating with a fault at the time in response to the stableness value meeting the first criterion and the deviation value meeting a second criterion,
the stableness value of the variable meeting the first criterion if the stableness value is less than a stability threshold.

5. The system of claim 1, wherein a number of detection devices in the set of detection devices is based on a set of permissible values for the criterion value.

6. The system of claim 1, wherein:
the criterion is a first criterion and the criterion value is a first criterion value,
the processor of each detection device from the set of detection devices further configured to analyze the observation value based on a second criterion associated with that detection device from the set of detection devices, the second criterion associated with each detection device from the set of detection devices being associated with a second criterion value associated with that detection device from the set of detection devices, the second criterion value associated with each detection device from the set of detection devices being different than the second criterion value associated with each remaining detection device from the set of detection devices, and
a number of detection devices in the set of detection devices being based on a set of permissible permutations of the first criterion value and the second criterion value.

7. The system of claim 1, wherein:
the criterion value for at least one detection device from the set of detection devices includes an indication of the host device as operating without fault, and
the processor of the group device is configured to compute the indication of the state of the host device as an indication of the host device as operating with fault when a predetermined number of the criterion values received from the set of detection devices indicate the host device as operating with fault.

8. The system of claim 1, wherein:
the criterion value for at least one detection device from the set of detection devices includes an indication of the host device as operating without fault, and
the processor of the group device is configured to compute the indication of the state of the host device as an indication of the host device as operating with fault when at least one criterion value received from the set of detection devices indicates the host device as operating with fault.

9. The system of claim 1, wherein:
the criterion value for at least one detection device from the set of detection devices includes an indication of the host device as operating without fault, and
the processor of the group device is configured to compute the indication of the state of the host device as an indication of the host device as operating with fault when each criterion value received from the set of detection devices indicates the host device as operating with fault.

10. The system of claim 1, wherein:
the processor of each detection device from the set of detection devices is further configured to:
compute a deviation value of the variable from a baseline value at the time based on the observation value;
compute a reliability measure based on the deviation value, the reliability measure includes (1) an indication of that detection device as being reliable if the deviation value of the variable is greater than or equal to a normalcy threshold for the variable, and (2) an indication of that detection device as being unreliable if the deviation value of the variable is less than the normalcy threshold for the variable; and
transmit an indication of the reliability measure to the group device,
the processor of the group device further configured to:
receive the indication of the reliability measure from each detection device from the set of detection devices;
deem a detection device from the set of detection devices as reliable based on the reliability measure of the detection device; and
compute the indication of the state of the host device based at least in part on the outcome from the set of outcomes and associated with the detection device from the set of detection devices deemed as reliable.

11. The system of claim 1, wherein:
the processor of each detection device from the set of detection devices is further configured to:
compute a deviation value of the variable from a baseline value at the time based on the observation value;
compute an upper limit for the deviation value based on an exponentially weighted moving average (EWMA) of the deviation value;
compute a lower limit for the deviation value based on the EWMA of the deviation value;
compute a normalcy range for the variable based on the upper limit for the deviation value and the lower limit for the deviation value;
compute a reliability measure based on the deviation value, the reliability measure includes (1) an indication of that detection device as being reliable if the deviation value of the variable is within the normalcy range for the variable, and (2) an indication of that detection device as being unreliable if the deviation value of the variable is outside the normalcy range for the variable; and
transmit an indication of the reliability measure to the group device; and
the processor of the group device further configured to:
receive the indication of the reliability measure from each detection device from the set of detection devices;
for each detection device from the set of detection devices, identify a detection device from the set of detection devices as reliable based on the reliability measure of that detection device; and
compute the indication of the state of the host device based at least in part on the outcome of each detection device from the set of detection devices identified as reliable.

12. The system of claim 1, wherein:
the observation value is an actual observation value,
the processor of each detection device from the set of detection devices further configured to:
compute an estimated observation value associated with the actual observation value; and
transmit an indication of the actual observation value and an indication of the estimated observation value to the group device; and
the processor of the group device further configured to:
receive the indication of the estimated observation value and the indication of the actual observation value from each detection device from the set of detection devices;
for each detection device from the set of detection devices:
compute an error between the estimated observation value and the actual observation value for that detection device; and
deem that detection device as reliable when the error meets a reliability criterion.

13. The system of claim 1, wherein:
the observation value is an actual observation value,
the processor of each detection device from the set of detection devices further configured to:
compute an estimated observation value associated with the actual observation value; and
transmit an indication of the actual observation value and an indication of the estimated observation value to the group device; and
the processor of the group device further configured to:
receive the indication of the estimated observation value and the indication of the actual observation value from each detection device from the set of detection devices; and
for each detection device from the set of detection devices:
compute an exponentially weighted moving average (EWMA) of an error between the estimated observation value and the actual observation value for that detection device; and
deem that detection device as reliable when the EWMA of the error meets a reliability criterion.

14. The system of claim 1, wherein:
the observation value is an actual observation value,
the processor of each detection device from the set of detection devices further configured to:
compute an estimated observation value associated with the actual observation value; and
transmit an indication of the actual observation value and an indication of the estimated observation value to the group device; and
the processor of the group device further configured to:
receive the indication of the estimated observation value and the indication of the actual observation value from each detection device from the set of detection devices; and
for each detection device from the set of detection devices, compute an exponentially weighted moving average (EWMA) of an error between the estimated observation value and the actual observation value for that detection device, to generate a set of EWMA of errors associated with the set of detection devices; and
identify the state of the host device based on the outcome associated with the detection device from the set of detection devices having the lowest EWMA of error from the set of EWMA of errors.

15. The system of claim 1, wherein:
the observation value is an actual observation value,
the processor of each detection device from the set of detection devices further configured to:
compute an estimated observation value associated with the actual observation value; and
transmit an indication of the actual observation value and an indication of the estimated observation value to the group device; and
the processor of the group device further configured to:
receive the indication of the estimated observation value and the indication of the actual observation value from each detection device from the set of detection devices; and
for each detection device from the set of detection devices, compute an exponentially weighted moving average (EWMA) of an error between the estimated observation value and the actual observation value for that detection device, to generate a set of EWMA of errors associated with the set of detection devices;
compute, for each detection device from the set of detection devices, a weighted outcome based on the outcome for that detection device weighted by the EWMA of error for that detection device to generate a set of weighted outcomes; and
compute the state of the host device based on the set of weighted outcomes.

16. A method, comprising:
receiving, at a detection device in a network, an observation value for a variable, the observation value for the variable associated with operation of a host device in the network at a time;
analyzing, at the detection device, the observation value based on a criterion to generate an outcome, the criterion being associated with a criterion value, the criterion value associated with the detection device being different than a criterion value associated with other detection devices in the network;
sending, to a group device in the network, the outcome such that the group device computes an indication of a state of the host device based on the outcome.

17. The method of claim 16, wherein the criterion is a first criterion, the analyzing further including, at the detection device:
determining that a predetermined number of observations for the variable has been received prior to the time;
computing a deviation value for the variable from a baseline value based on the observation value and based on the predetermined number of observations; and
generating the outcome as an indication that the host device is operating with a fault at the time in response to the deviation value meeting the first criterion and the observation value meeting a second criterion,
the deviation value of the variable meeting the first criterion if the deviation value of the variable is greater than or equal to a normalcy threshold for the variable.

18. The method of claim 16, wherein a number of detection devices that includes the detection device and other detection devices is based on a set of permissible values associated with the criterion value.

19. The method of claim 16, further comprising, at the detection device:
computing a deviation value of the variable from a baseline value at the time based on the observation value;
computing an upper limit for the deviation value based on an exponentially weighted moving average (EWMA) of the deviation value;
computing a lower limit for the deviation value based on the EWMA of the deviation value;
computing a normalcy range for the variable based on the upper limit for the deviation value and the lower limit for the deviation value;
computing a reliability measure based on the deviation value, the reliability measure includes an indication of the detection device as being reliable if the deviation value of the variable is within the normalcy range for the variable, and includes an indication of the detection device as being unreliable if the deviation value of the variable is outside the normalcy range for the variable; and
deeming the detection device as reliable based on the reliability measure,
such that the host device computes the indication of the state of the host device based at least in part on the outcome of the detection device and based on the detection device being deemed as reliable.

20. A device operably coupled to a network, comprising:
a processor configured to:
receive a set of outcomes from a set of detection devices via the network, each outcome from the set of outcomes generated by a different detection device from the set of detection devices, each outcome from the set of outcomes based on an observation value that is for a variable and that is associated with operation of a host device in the network at a time, each outcome from the set of outcomes further based on a criterion associated with a criterion value that is associated with each detection device from the set of detection devices and that is different than the criterion value associated with each remaining detection device from the set of detection devices;
compute an indication of a state of the host device as operating with or without fault based on the set of outcomes; and
transmit, over the network, the indication of the state of the host device; and
a database operatively coupled to the processor, the database configured to store at least one of the observation value, the set of outcomes, or the indication of the state of the host device.

21. The device of claim 20, wherein:
the criterion value for at least one detection device from the set of detection devices includes an indication of the host device as operating without fault, and
the processor is configured to compute the indication of the state of the host device as an indication of the host device as operating with fault when a predetermined number of the criterion values received from the set of detection devices indicate the host device as operating with fault.

22. The device of claim 20, wherein:
the criterion value for at least one detection device from the set of detection devices includes an indication of the host device as operating without fault, and
the processor is configured to compute the indication of the state of the host device as an indication of the host device as operating with fault when at least one criterion value received from the set of detection devices indicates the host device as operating with fault.

23. The device of claim 20, wherein:
the criterion value for at least one detection device from the set of detection devices includes an indication of the host device as operating without fault, and
the processor is configured to compute the indication of the state of the host device as an indication of the host device as operating with fault when each criterion value received from the set of detection devices indicates the host device as operating with fault.
